(19) United States
(12) Patent Application Publication
(10) Pub. No.: US 2015/0214627 A1
(43) Pub. Date: Jul. 30, 2015

(54) ANTENNA APPARATUS AND ELECTRONIC DEVICE

(71) Applicant: CANON COMPONENTS, INC., Kodama-gun (JP)

(72) Inventors: Mitsuo KOMORIYA, Saitama (JP); Osamu KANOME, Saitama (JP); Yoshihisa NEGISHI, Saitama (JP)

(21) Appl. No.: 14/603,549

(22) Filed: Jan. 23, 2015

(30) Foreign Application Priority Data
Jan. 24, 2014 (JP) 2014-011457
Mar. 6, 2014 (JP) 2014-044078

(51) Int. Cl. H01Q 9/04; H01Q 1/38

(52) U.S. Cl. CPC H01Q 9/0471; H01Q 1/38

(57) ABSTRACT

Provided is an antenna unit performing at least one of transmission and reception of data, the antenna unit including: a resin substrate including projections and recesses formed parallel to and adjacent to each other on an upper surface; and an antenna conductor continuously formed to meander in one direction along top portions of the projections and bottom portions of the recesses.

### CROSS-REFERENCE TO RELATED APPLICATIONS

This application is based upon and claims the benefit of priority of the prior Japanese Patent Application No. 2014-011457, filed on Jan. 24, 2014, and the prior Japanese Patent Application No. 2014-044078, filed on Mar. 6, 2014, the entire contents of which are incorporated herein by reference.

### BACKGROUND OF THE INVENTION

1. Field of the Invention

The present invention relates to an antenna apparatus and an electronic device used for transmission and reception of data.

2. Description of the Related Art

In recent years, downsizing of a wireless communication apparatus, such as a wireless LAN and an RFID, used in an electronic device, such as a digital camera, a printer, and a mobile phone, is demanded. Therefore, downsizing of an antenna apparatus mounted on or connected to the wireless communication apparatus is also demanded. Particularly, electronic components, such as a communication circuit, are mounted on the same substrate in the antenna apparatus formed as an antenna pattern on the substrate, and reduction in the area of the antenna pattern on the substrate is demanded.

Patent Document 1 discloses an emission-type antenna used for a wireless LAN and the like. The antenna of Patent Document 1 includes an antenna conductor provided with a meandering portion in which meandering advances in a certain direction from a base end.

Patent Document 2 discloses an electromagnetic-induction antenna used in an RFID system for electric payment, security authentication, logistics management, and the like. In the RFID system, data can be transmitted and received in a non-contact manner between, for example, a reader/writer apparatus and a wireless communication medium such as a non-contact IC card. Antennas using electromagnetic induction are widely used in the reader/writer apparatus and the IC card. The antenna of Patent Document 2 includes a looped antenna coil portion formed on an insulating substrate.

### Patent Document 1

### Japanese Laid-open Patent Publication No. 2002-190706

### Patent Document 2

### Japanese Laid-open Patent Publication No. 2004-112020

To downsize the meandering antenna disclosed in Patent Document 1, there are a method of reducing a line width of conductors and a method of narrowing down intervals between adjacent conductors, for example. However, when the line width of the conductors is reduced, the bandwidth is reduced, and a desired communication bandwidth may not be secured. When the intervals between adjacent conductors are narrowed down, the capacitive coupling between the adjacent conductors becomes strong, and the resonance frequency may be shifted to a high frequency. As a result, the number of folds of the conductors needs to be increased, or the length of the folds needs to be long. Therefore, downsizing of the meandering antenna is difficult.

To downsize an electromagnetic-induction looped antenna disclosed in Patent Document 2, there is a method of reducing a line width of a conductor, for example. However, when the line width of the conductor is reduced, the resistance of an antenna conductor may increase. For example, in the reader/writer apparatus, the resistance loss may increase due to the increase in the resistance of the conductor, and the power consumption may increase. In the IC card, the increase in the resistance of the conductor may reduce the induction voltage generated by receiving a magnetic field from the antenna of the reader/writer apparatus.

In this way, there are problems in the emission type and the electromagnetic-induction type that necessary characteristics cannot be obtained when the antenna apparatus is downsized.

### SUMMARY OF THE INVENTION

The present invention has been made in view of the problems, and an object of the present invention is to downsize an antenna apparatus while keeping necessary characteristics.

The present invention provides an antenna apparatus performing at least one of transmission and reception of data, the antenna apparatus including: a substrate including projections and recesses formed parallel to and adjacent to each other on an upper surface; and an antenna conductor continuously formed to meander in one direction along top portions of the projections or bottom portions of the recesses.

The present invention provides an antenna apparatus performing at least one of transmission and reception of data, the antenna apparatus including: a substrate including projections and recesses formed parallel to and adjacent to each other on an upper surface; and an antenna conductor continuously formed to meander in one direction along top portions of the projections and bottom portions of the recesses.

The present invention provides an antenna apparatus performing at least one of transmission and reception of data, the antenna apparatus including: a substrate including projections or recesses wound and formed on an upper surface; and an antenna conductor formed along top portions of the projections or bottom portions of the recesses.

The present invention provides an antenna apparatus performing at least one of transmission and reception of data, the antenna apparatus including: a substrate including projections and recesses alternately wound and formed on an upper surface; and an antenna conductor formed in a spiral shape along top portions of the projections or bottom portions of the recesses.

The present invention provides an electronic device including: an antenna unit performing at least one of transmission and reception of data; and a communication circuit performing at least one of conversion of data received at the antenna unit and conversion to data to be transmitted from the antenna unit, the antenna unit including: a substrate including projections and recesses formed parallel to and adjacent to each other on an upper surface; and an antenna conductor continuously formed to meander in one direction along top portions of the projections or bottom portions of the recesses.

The present invention provides an electronic device including: an antenna unit performing at least one of transmission and reception of data; and a communication circuit performing at least one of conversion of data received at the antenna unit and conversion to data to be transmitted from the antenna unit, the antenna unit including: a substrate including projections and recesses formed parallel to and adjacent to each other on an upper surface; and an antenna conductor continuously formed to meander in one direction along top portions of the projections and bottom portions of the recesses.

The present invention provides an electronic device including: an antenna unit performing at least one of transmission and reception of data; and a communication circuit performing at least one of conversion of data received at the antenna unit and conversion to data to be transmitted from the antenna unit, the antenna unit including: a substrate including projections or recesses wound and formed on an upper surface; and an antenna conductor formed along top portions of the projections or bottom portions of the recesses.

The present invention provides an electronic device including: an antenna unit performing at least one of transmission and reception of data; and a communication circuit performing at least one of conversion of data received at the antenna unit and conversion to data to be transmitted from the antenna unit, the antenna unit including: a substrate including projections and recesses alternately wound and formed on an upper surface; and an antenna conductor formed in a spiral shape along top portions of the projections or bottom portions of the recesses.

The present invention provides an electronic device including: an antenna unit performing at least one of transmission and reception of data; and a communication circuit performing at least one of conversion of data received at the antenna unit and conversion to data to be transmitted from the antenna unit, the antenna unit including: a substrate including projections and recesses alternately wound and formed on an upper surface; and an antenna conductor formed in a spiral shape along top portions of the projections and bottom portions of the recesses.

### BRIEF DESCRIPTION OF THE DRAWINGS

FIG. 1 is a sectional view of a wireless communication module 10 of a first embodiment;

FIG. 2 is a view illustrating an internal configuration of the wireless communication module 10;

FIG. 3 is a perspective view showing an external configuration of the wireless communication module 10;

FIG. 4 is a plan view of the wireless communication module 10;

FIG. 5 is an enlarged sectional view of a resin substrate 21;

FIG. 6 is a perspective view of an antenna unit 20;

FIG. 7A is a plan view of an antenna unit 40 of an example;

FIG. 7B is a sectional view of the antenna unit 40 of the example;

FIG. 8A is a plan view of an antenna unit 50 of a comparative example;

FIG. 8B is a sectional view of the antenna unit 50 of the comparative example;

FIG. 9 is a diagram comparing reflection characteristics of the example and the comparative example;

FIG. 10A is a plan view of an antenna unit 60 of a second embodiment;

FIG. 10B is a sectional view of the antenna unit 60;

FIG. 11A is a plan view of an antenna unit 70 of a comparison mode;

FIG. 11B is a sectional view of the antenna unit 70;

FIG. 12A is a sectional view of an antenna unit 80 of a third embodiment;

FIG. 12B is a sectional view of an antenna unit 85 of a fourth embodiment;

FIG. 12C is a sectional view of an antenna unit 90 of a fifth embodiment;

FIG. 12D is a sectional view of an antenna unit 95 of a sixth embodiment;

FIG. 12E is a sectional view of an antenna unit 105 of a seventh embodiment;

FIG. 12F is a sectional view of an antenna unit 110 of an eighth embodiment;

FIG. 12G is a sectional view of an antenna unit 115 of a ninth embodiment;

FIG. 13A is a plan view of an antenna unit 100 of a tenth embodiment;

FIG. 13B is a sectional view of the antenna unit 100;

FIG. 13C is a sectional view of the antenna unit 100;

FIG. 14 is a view illustrating an example of a configuration of an RFID system 201 of an eleventh embodiment;

FIG. 15 is a plan view of an IC card 220;

FIG. 16 is a partial sectional view of the IC card 220;

FIG. 17 is an enlarged sectional view of a resin substrate 242;

FIG. 18 is a plan view of the resin substrate 242;

FIG. 19 is a perspective view of the resin substrate 242;

FIG. 20A is a plan view of an antenna unit 260 of an example;

FIG. 20B is a sectional view of the antenna unit 260 of the example;

FIG. 21A is a plan view of an antenna unit 270 of a comparative example;

FIG. 21B is a sectional view of the antenna unit 270 of the comparative example;

FIG. 22A is a diagram comparing resistance of the example and resistance of the comparative example;

FIG. 22B is a view illustrating a relationship between a depth D and a resistance reduction effect of the example;

FIG. 23A is a diagram comparing inductance of the example and inductance of the comparative example;

FIG. 23B is a view illustrating a relationship between the depth D and change in the inductance of the example;

FIG. 24 is a plan view of a resin substrate 310 of a twelfth embodiment;

FIG. 25 is a perspective view of the resin substrate 310;

FIG. 26A is a sectional view of an antenna unit 350 of a thirteenth embodiment;

FIG. 26B is a sectional view of an antenna unit 355 of a fourteenth embodiment;

FIG. 26C is a sectional view of an antenna unit 360 of a fifteenth embodiment;

FIG. 26D is a sectional view of an antenna unit 365 of a sixteenth embodiment;

FIG. 26E is a sectional view of an antenna unit 370 of a seventeenth embodiment;

FIG. 26F is a sectional view of an antenna unit 375 of an eighteenth embodiment;

FIG. 26G is a sectional view of an antenna unit 380 of a nineteenth embodiment;

FIG. 26H is a sectional view of an antenna unit 385 of a twentieth embodiment;

FIG. 27 is a sectional view of an antenna unit 390 of a twenty-first embodiment;

FIG. 28A is a diagram comparing the resistance of an example and the resistance of a comparative example;

FIG. 28B is a view illustrating a relationship between the depth D and the resistance reduction effect of the example;

FIG. 29A is a diagram comparing the inductance of the example and the inductance of the comparative example;

FIG. 29B is a view illustrating a relationship between the depth D and change in the inductance of the example;

FIG. 30 is a sectional view of an antenna unit 320 of a twenty-second embodiment;

FIG. 31 is a sectional view of an antenna unit 330 of a twenty-third embodiment;

FIG. 32 is a sectional view of an antenna unit 410 of a twenty-fourth embodiment;

FIG. 33A is a diagram comparing the resistance of an example and the resistance of a comparative example;

FIG. 33B is a view illustrating a relationship between the depth D and the resistance reduction effect of the example;

FIG. 34A is a diagram comparing the inductance of the example and the inductance of the comparative example;

FIG. 34B is a view illustrating a relationship between the depth D and change in the inductance of the example;

FIG. 35 is a sectional view of an antenna unit 415 of a twenty-fifth embodiment;

FIG. 36A is a diagram comparing the resistance of an example and the resistance of a comparative example;

FIG. 36B is a view illustrating a relationship between the depth D and the resistance reduction effect of the example;

FIG. 37A is a diagram comparing the inductance of the example and the inductance of the comparative example;

FIG. 37B is a view illustrating a relationship between the depth D and change in the inductance of the example;

FIG. 38 is a plan view of a resin substrate 411 of a twenty-fourth embodiment and a resin substrate 416 of a twenty-fifth embodiment; and

FIG. 39 is a perspective view of an antenna unit 420 of a twenty-sixth embodiment.

### DETAILED DESCRIPTION OF THE PREFERRED EMBODIMENTS

Hereinafter, embodiments according to the present invention will be described with reference to the drawings.

### First Embodiment

The present embodiment provides: an emission-type antenna apparatus that can perform at least of transmission and reception of data to and from an external apparatus; and an electronic device 1 provided with the antenna apparatus. In the present embodiment, the electronic device 1 can be, for example, a digital camera, a printer, or a mobile phone.

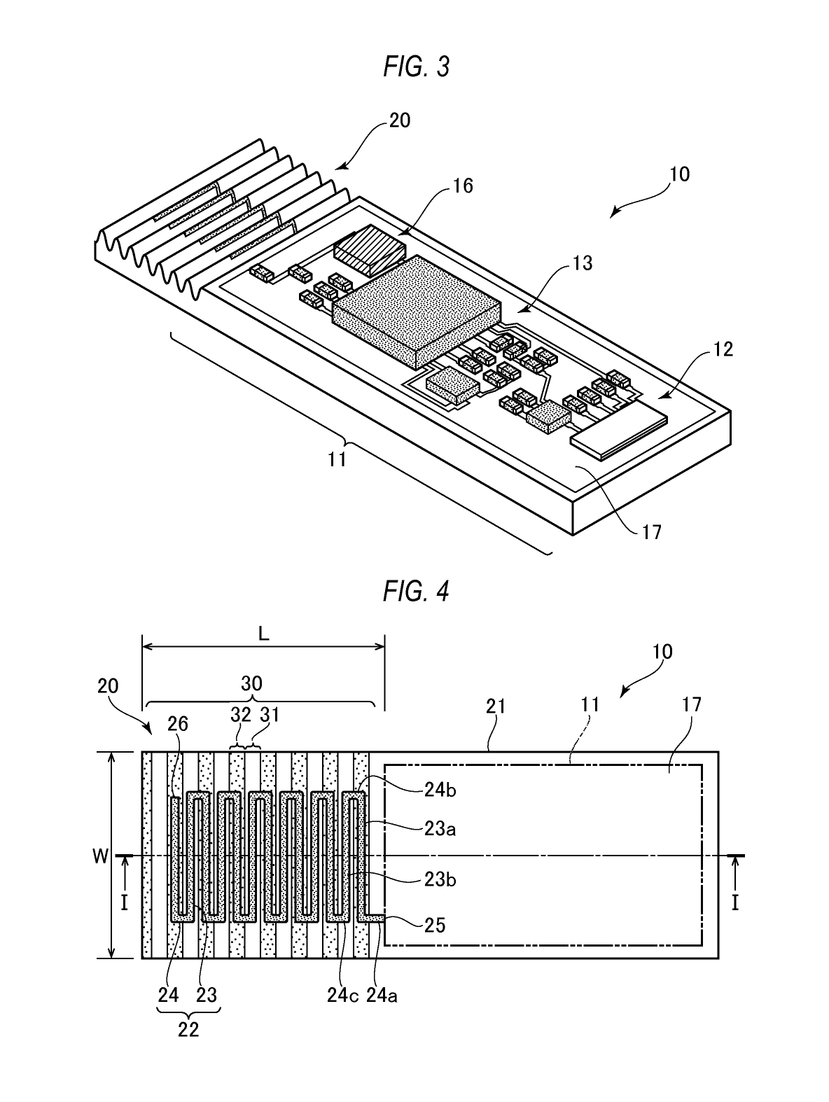

FIG. 2 is a view illustrating an example of an internal configuration of a wireless communication module 10 embedded in the electronic device 1. FIG. 3 is a perspective view illustrating an example of a general configuration of the wireless communication module 10.

The wireless communication module 10 includes a mounting section 11 and an antenna unit 20 that functions as an antenna apparatus. As illustrated in FIG. 2, the mounting section 11 includes an interface 12, a communication circuit 13, and a switch 16. The interface 12 inputs and outputs data signals to and from a device body 18. The device body 18 includes a control substrate to control the entire wireless communication module 10.

The communication circuit 13 includes a reception circuit 14 and a transmission circuit 15. The reception circuit 14 demodulates a high frequency signal received by the antenna unit 20 to reduce the frequency to convert the signal to a data signal. The transmission circuit 15 modulates and amplifies a data signal input from the device body 18 through the interface 12 to convert the signal to a high frequency signal.

The switch 16 switches circuits connected to the antenna unit 20. Specifically, the switch 16 connects the transmission circuit 15 and the antenna unit 20 to transmit a high frequency signal and connects the reception circuit 14 and the antenna unit 20 to receive a high frequency signal.

As illustrated in FIG. 3, a grounding conductor is formed on a mounting surface 17 (including a mounting surface 17 of a region including the interface 12, the communication circuit 13, the switch 16, and the like and a region provided with wires) in the mounting section 11. The grounding conductor may be formed on the back surface of the mounting surface 17. Both surfaces of the mounting section 11 may be the mounting surfaces 17, and grounding conductors may be formed on the mounting surfaces 17 (including mounting surfaces 17 in a region including a circuit and the like and a region provided with wires). Characteristics of the antenna unit 20 that can be kept increase with an increase in the area of the grounding conductor, and it is preferable to form the wireless communication module 10 so that a wide grounding conductor can be formed.

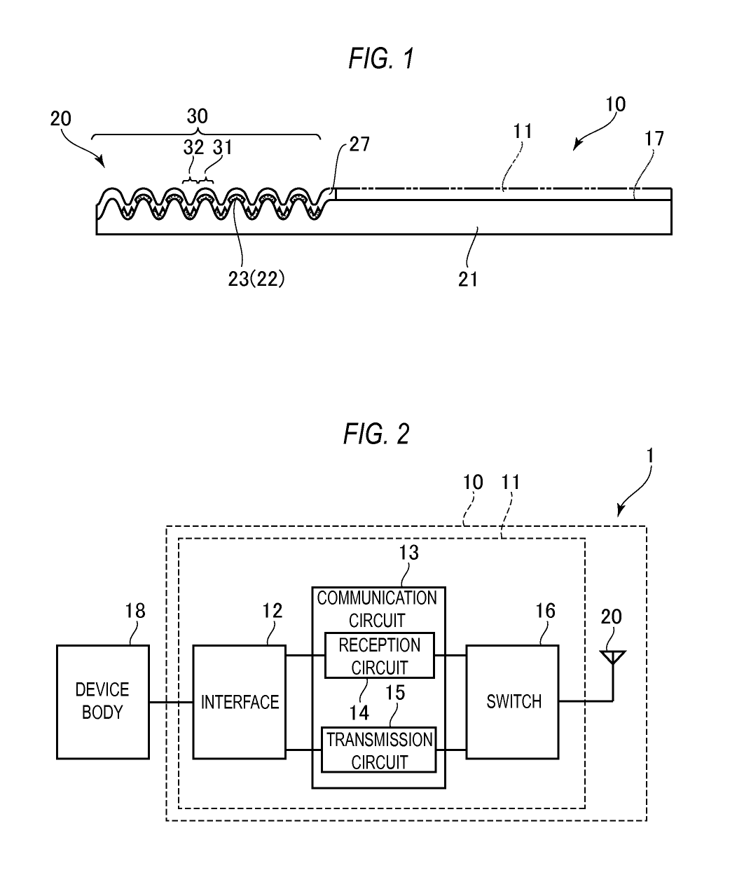

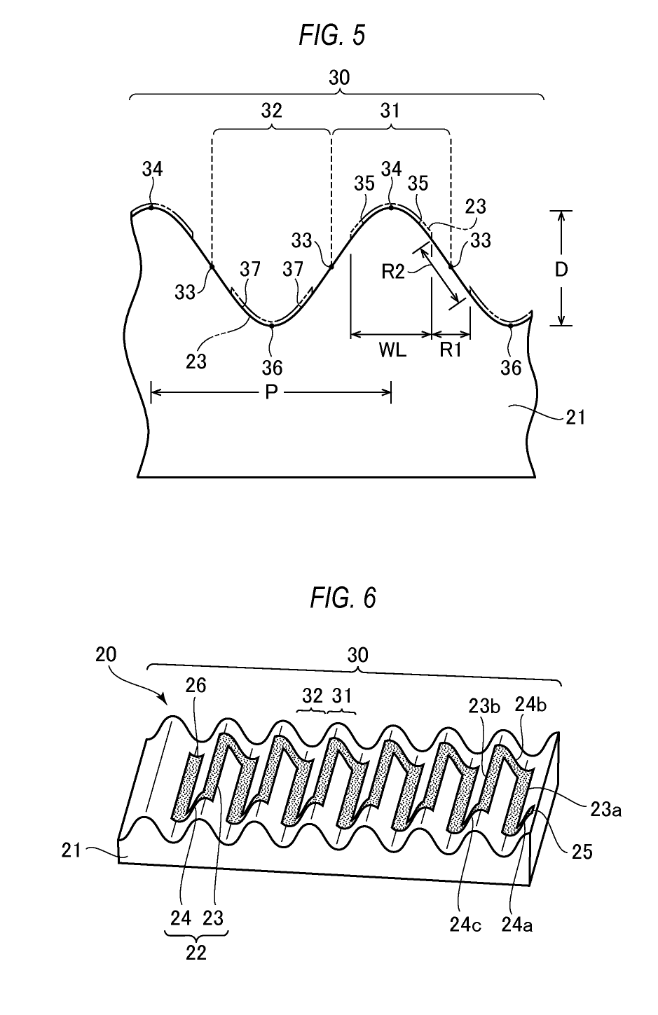

A configuration of the antenna unit 20 of the present embodiment will be described with reference to FIGS. 1, 4, 5, and 6. FIG. 4 is a plan view (top view) of the wireless communication module 10. FIG. 1 is a sectional view of a I-I line illustrated in FIG. 4. Circuits and the like mounted on the mounting section 11 are not illustrated. FIG. 5 is an enlarged sectional view of a resin substrate 21 illustrated in FIG. 1. FIG. 6 is a perspective view of the antenna unit 20.

As illustrated in FIG. 1, the resin substrate 21 as a substrate, an antenna conductor 22 provided with a meandering pattern on the resin substrate 21, and a solder resist 27 are sequentially laminated over the antenna unit 20. As illustrated in FIG. 4, meandering denotes a form that the antenna conductor 22 meanders and extends in one direction, a length direction of the resin substrate 21 here (direction L illustrated in FIG. 4 (extension direction)), in plan view of the resin substrate 21. Hereinafter, a direction (direction W illustrated in FIG. 4) orthogonal to the length direction of the resin substrate 21 will be called a width direction of the resin substrate 21.

As illustrated in FIGS. 4 and 6, the antenna conductor 22 includes meandering width portions 23 as first line portions and meandering extension portions 24 as second line portions. In the meandering width portion 23, the antenna conductor 22 is formed in the width direction of the resin substrate 21. The meandering extension portion 24 is formed in the direction of the extension of the antenna conductor 22, which is the length direction of the resin substrate 21.

In the antenna conductor 22, the meandering extension portions 24 and the meandering width portions 23 are alternately formed from a feeding portion 25 close to the mounting section 11 to a tip portion 26, and the antenna conductor 22 is folded back from the meandering width portions 23 through the meandering extension portions 24 to meander and extend in the length direction. Specifically, the meandering width portions 23 and the meandering extension portions 24 are sequentially formed from the feeding portion 25 to the tip portion 26 through a meandering extension portion 24a, a meandering width portion 23a directed toward one end in the width direction, a meandering extension portion 24b, a meandering width portion 23b directed toward the other end in the width direction, a meandering extension portion 24c, and the like.

In other words, the antenna conductor 22 is formed by the meandering extension portions 24 connecting end portions of adjacent meandering width portions 23 formed parallel to each other in the width direction. In this case, the meandering extension portions 24 alternately connect the meandering width portions 23 on the one end side and the other end side in the width direction.

In the present embodiment, the antenna conductor 22 is formed on projections and recesses 30 of the resin substrate 21 to downsize the antenna unit 20. Specifically, as illustrated in FIG. 1, the projections and recesses 30 in the width direction are formed on the upper surface of the resin substrate 21. Projections 31 and recesses 32 are arranged parallel to and adjacent to each other to form the projections and recesses 30.

As illustrated in FIG. 5, the projections and recesses 30 of the present embodiment have a so-called sine wave shape, and the same shape is formed at each pitch P in the length direction. A top portion of the projection 31 and a bottom portion of the recess 32 are curved. More specifically, inclined surfaces 35 inclined toward adjacent recesses 32 from an uppermost portion 34 are formed on the projection 31. Similarly, inclined surfaces 37 inclined toward adjacent projections 31 from a lowermost portion 36 are formed on the recess 32. In the projections and recesses 30, a position at the middle of a depth D from the projection 31 to the recess 32 is a boundary portion 33 of the projection 31 and the recess 32. In the present embodiment, the boundary portion 33 is an intermediate position between the uppermost portion 34 and the lowermost portion 36. The boundary portion 33 of the present embodiment is inclined in the thickness direction with respect to the resin substrate 21. Therefore, the surface of the boundary portion 33 is exposed in plan view, and the boundary portion 33 can be recognized from the upper surface.

As illustrated in FIG. 6, the meandering width portions 23 of the antenna conductor 22 of the present embodiment are alternately formed along top portions (upper surfaces) of the projections 31 and bottom portions (upper surfaces) of the recesses 32. Specifically, as illustrated by an alternate long and two short dashes line of FIG. 5, the meandering width portion 23 formed on the top portion of the projection 31 is formed from the uppermost portion 34 of the projection 31 throughout the inclined surfaces 35 on both sides. On the other hand, the meandering width portion 23 formed on the bottom portion of the recess 32 is formed from the lowermost portion 36 of the recess 32 throughout the inclined surfaces 37 on both sides. In this way, the meandering width portion 23 is formed throughout the inclined surfaces 35 and 37, and the substantial line width of the meandering width portion 23 including the inclination is wide. More specifically, the reduction in the substantial line width of the meandering width portion 23 including the inclination can be suppressed even if the line width (WL illustrated in FIG. 5) of the meandering width portion 23 is reduced in plan view in order to downsize the antenna unit 20. Therefore, the reduction in the bandwidth caused by the reduction in the line width of the conductor can be suppressed, and the area of the antenna conductor 22 on the substrate can be reduced while maintaining a desired communication bandwidth.

Furthermore, a gap is formed between adjacent meandering width portions 23, which are the meandering width portion 23 formed on the top portion of the projection 31 and the meandering width portion 23 formed on the bottom portion of the recess 32, through the inclined boundary portion 33. Therefore, the interval between the adjacent meandering width portions 23 is also separated in the thickness direction of the resin substrate 21, in addition to the extension direction. In this way, the interval between the adjacent meandering width portions 23 is also separated in the thickness direction, and the substantial interval between the adjacent meandering width portions 23 is wide. More specifically, even if an interval (R1 illustrated in FIG. 5) between the adjacent meandering width portions 23 in plan view is narrowed down in order to downsize the antenna unit 20, the reduction of a substantial interval (R2 illustrated in FIG. 5) between the adjacent meandering width portions 23 including the components in the thickness direction can be suppressed. Therefore, the capacitive coupling caused by the reduction in the gap between adjacent conductors can be suppressed, and the antenna unit 20 can be downsized while maintaining a desired resonance frequency.

Meanwhile, the meandering extension portion 24 of the antenna conductor 22 is formed throughout the top portion of the projection 31 and the bottom portion of the recess 32. More specifically, the meandering extension portion 24 is formed throughout the inclined surfaces 35 of the projection 31, the boundary portion 33, and the inclined surfaces 37 of the recess 32.

A method of manufacturing the wireless communication module 10 including the antenna unit 20 will be described.

First, the resin substrate 21 provided with the projections and recesses 30 is manufactured. Specifically, a molten resin is extruded to mold a molten resin sheet, and before the molded molten resin sheet is cured, the sheet is pressured by a mirror surface roll and a resin roll, which includes a peripheral surface covered by a resin, to form a resin sheet. In the formed resin sheet, a photocurable resin composition layer is formed on the upper surface of the surface pressed against the resin roll, and the projections and recesses 30 are formed on the formed photocurable resin composition layer. A thermoplastic polyimide resin is used for the molten resin, and a photocurable polyimide resin is used for the photocurable resin composition. The thickness of the resin sheet is 1.5 mm.

The resin sheet provided with the projections and recesses 30 is cut into a size manageable in subsequent steps, such as 250 mm×300 mm. A copper thin film is formed on the entire front and back surfaces of the resin sheet cut by electroless plating, and then a copper foil is formed at a thickness of 10 μm by electrolytic plating. Subsequently, a photoresist is applied, and a mask with repeatedly drawn meander patterns of the antenna conductor 22 and wiring patterns of the mounting section 11 is used to perform UV exposure. A resist pattern is formed on the copper foil by development, and etching is performed by a ferric chloride aqueous solution.

The resist is peeled off by a peeling solution. A solder resist layer may be formed over the copper foil to protect the copper foil. In this case, a screen mask can be used to form a film on the entire surface, and a mask with a solder resist pattern can be used to perform UV exposure. A solder resist of a necessary part of the mounting section 11 can be opened by a developer. The resin sheet can be cut for each repeated pattern to manufacture individual resin substrates. Lastly, necessary electronic components, such as the communication circuit 13, can be mounted on the mounting surface 17 of the manufactured resin substrate 21 to manufacture the wireless communication module 10.

In the formation of the meandering extension portion 24 on the boundary portion 33 of the projections and recesses 30, the copper foil can be easily formed on the surface of the boundary portion 33 because the surface of the boundary portion 33 is exposed in plan view in the present embodiment.

Reflection characteristics of an antenna unit 40 of an example with the configuration described above and reflection characteristics of an antenna unit 50 of a comparative example are analyzed by an electromagnetic field simulator.

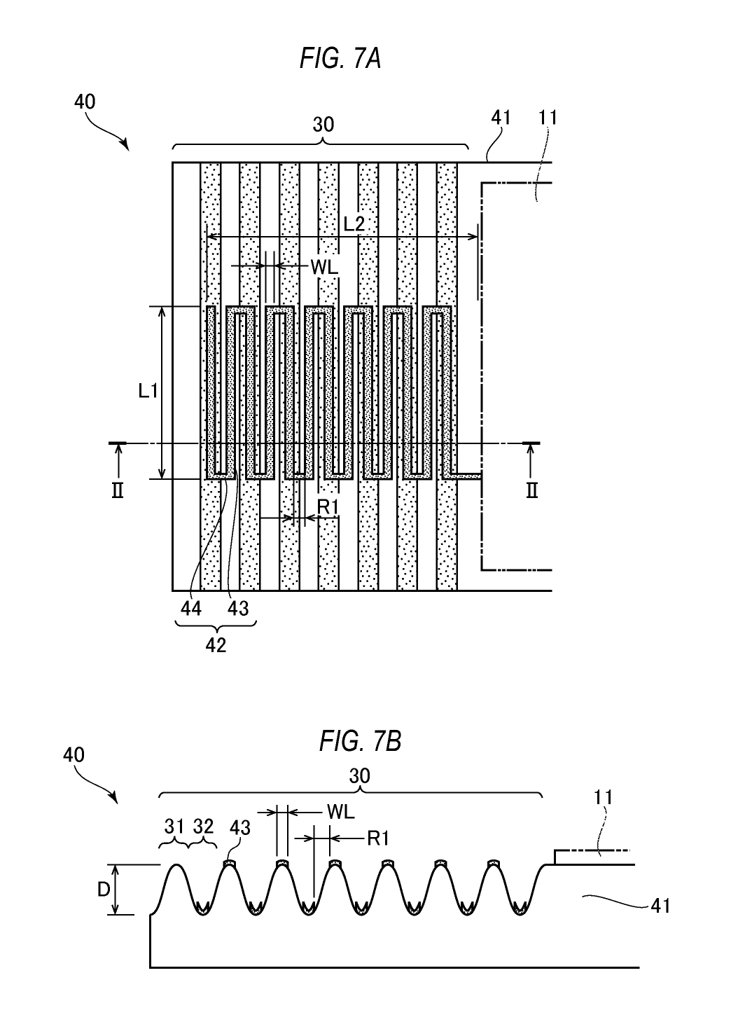

The dimension and the like of the antenna unit 40 of the example will be described with reference to FIGS. 7A and 7B. FIG. 7A is a plan view of the antenna unit 40 of the example. FIG. 7B is an enlarged sectional view of a II-II line illustrated in FIG. 7A. The solder resist is not illustrated.

In the example, the projections and recesses 30 of the resin substrate 41 are formed in a sine wave shape. A polyimide resin is used for the resin substrate 41, and the depth D from the projection 31 to the recess 32 is 1.0 mm. A copper foil is used for the antenna conductor 42, and the meandering width portions 43 and the meandering extension portions 44 form a meandering shape. As for the dimension in plan view, the line width WL of the antenna conductor 42 is 0.2 mm, the interval R1 between the meandering width portions 43 is 0.3 mm, a length L1 of the meandering width portions 43 is 2.6 mm, and a length L2 of the antenna conductor 42 in the extension direction is 6.6 mm. Therefore, the area of the antenna conductor 42 on the substrate is 6.6 mm×2.6 mm=17.16 mm².

Modeling of circuits and the like of the mounting section 11 is difficult, and the mounting section 11 is a grounding conductor in the analysis. The size of the grounding conductor is 25 mm×10 mm.

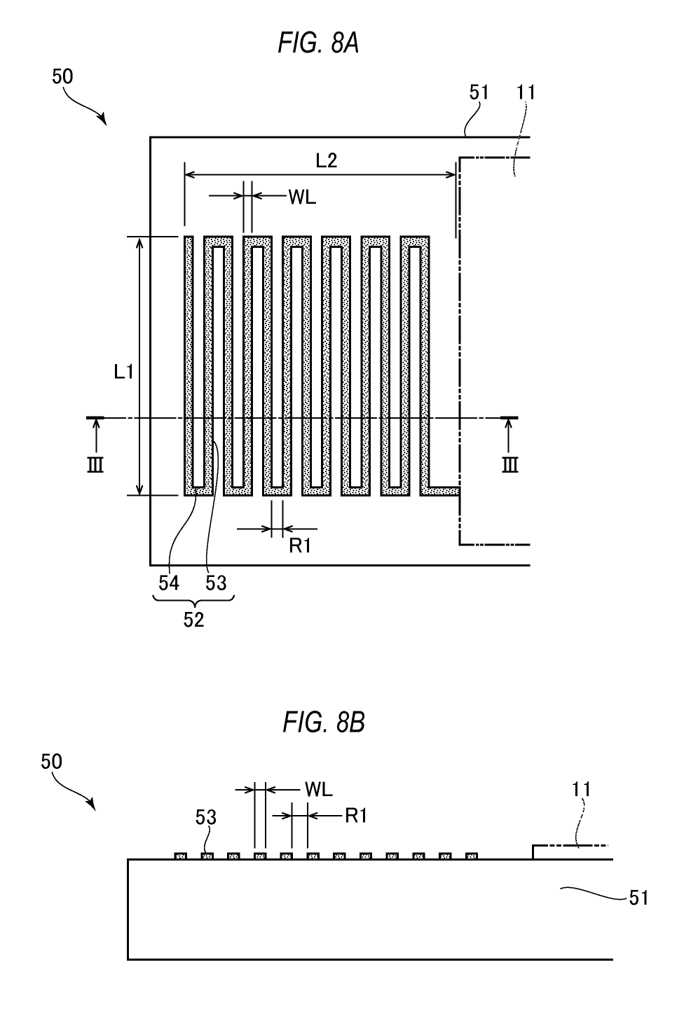

The dimension and the like of the antenna unit 50 of the comparative example will be described with reference to FIGS. 8A and 8B. FIG. 8A is a plan view of the antenna unit 50 of the comparative example. FIG. 8B is a sectional view of a line illustrated in FIG. 8A. The solder resist is not illustrated.

In the comparative example, a polyimide resin is used for a resin substrate 51. A copper foil is used for an antenna conductor 52, and meandering width portions 53 and meandering extension portions 54 form a meandering shape. As for the dimension in plan view, the line width WL of the antenna conductor 52 is 0.2 mm, and the interval R1 between the meandering width portions 53 is 0.3 mm. Meanwhile, the length L1 of the meandering width portions 53 is 4.4 mm, and the length L2 of the antenna conductor 52 in the extension direction is 6.6 mm. Therefore, the area of the antenna conductor 52 on the substrate is 6.6 mm×4.4 mm=29.04 mm². Thus, the area of the antenna conductor 52 on the substrate in the comparative example is greater than the area of the antenna conductor 42 on the substrate in the example.

Modeling of circuits and the like of the mounting section 11 is difficult, and the mounting section 11 is a grounding conductor in the analysis. The size of the grounding conductor is 25 mm×10 mm.

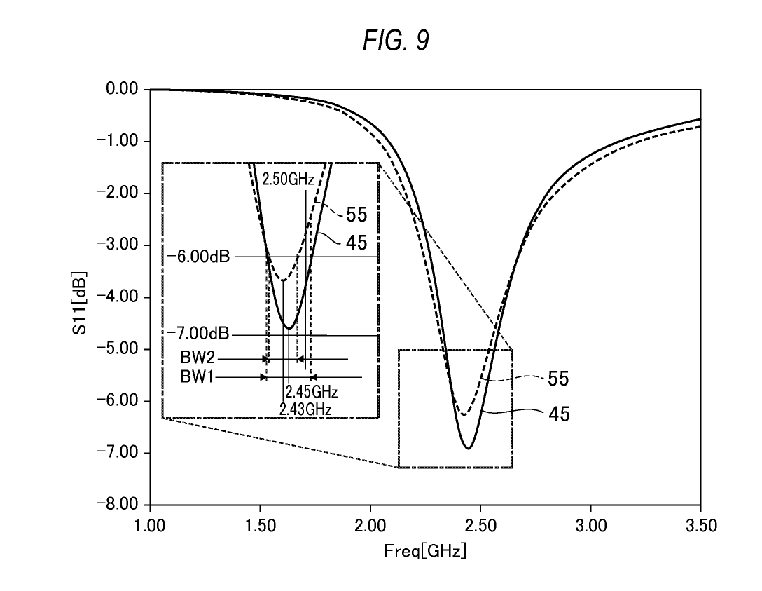

FIG. 9 is a diagram comparing simulation results of the reflection characteristics (S11) of the antenna unit 40 of the example and the antenna unit 50 of the comparative example. In FIG. 9, the vertical axis indicates S11 [dB], and the horizontal axis indicates the frequency [GHz]. S11 [dB] is an index expressing the size of reflection, indicating the proportion of reflected and returned power in the power fed from the feeding portion to the antenna. S11 [dB] is expressed by the following expression, wherein Pin [W] is the feed power, and Pr [W] is the reflection power.

$$S 11 [ dB ] = 10 log ( \frac{Pr}{Pin} ) \qquad [ Expression 1 ]$$

Here, the smaller the S11, the smaller the proportion of the reflection power, which means that most of the fed power is emitted from the antenna. On the other hand, the feed power is completely reflected and not emitted from the antenna unit when S11 is 0 dB. In FIG. 9, a solid line 45 indicates a characteristic line of the antenna unit 40 of the example, and a dashed line 55 indicates a characteristic line of the antenna unit 50 of the comparative example.

As shown in FIG. 9, the resonance frequency is 2.45 [GHz], and a communication bandwidth BW1 is 130 [MHz] in the antenna unit 40 of the example. The emission efficiency is 67.2%, and it can be recognized that the antenna unit 40 has characteristics that can handle communication at 2.4 [GHz] of wireless LAN standard IEEE 802.11. The communication bandwidth indicates a frequency range in which the value of S11 is −6 [dB] or less. The emission efficiency is efficiency including the loss caused by the reflection by the feeding portion 25, and the emission efficiency is calculated by dividing the emission power by the feed power.

Meanwhile, in the antenna unit 50 of the comparative example, the resonance frequency is 2.43 [GHz], a communication bandwidth BW2 is 80 [MHz], and the emission efficiency is 63.2%.

In this way, although the area of the antenna conductor 42 on the substrate in the antenna unit 40 of the example is 11 mm² or more smaller than the area of the antenna conductor 52 on the substrate in the antenna unit 50 of the comparative example, it can be confirmed that the communication bandwidth and the emission efficiency can have values equivalent to those of the antenna unit 50 of the comparative example.

Therefore, the resin substrate 21 including the projections and recesses 30 can be used to reduce the length of the meandering width portions 23 of the antenna conductor 22 to thereby reduce the area of the antenna conductor 22 on the substrate and to downsize the antenna unit 20 while maintaining the resonance frequency, the communication bandwidth, and the emission efficiency.

Although the length of the meandering width portion 43 is reduced in the antenna unit 40 of the example, the area on the substrate can also be reduced by narrowing down the intervals between adjacent meandering width portions 43 or by reducing the number of meandering extension portions 44 to reduce the number of folds. Furthermore, the deeper the depth D of the projections and recesses 30 formed on the resin substrate 41 is, the more the area on the substrate can be reduced.

### Second Embodiment

Although the projections and recesses 30 are formed in a sine wave shape in the description of the first embodiment, the projections and recesses 30 of a resin substrate 61 is formed in a rectangular shape in the description of the present embodiment.

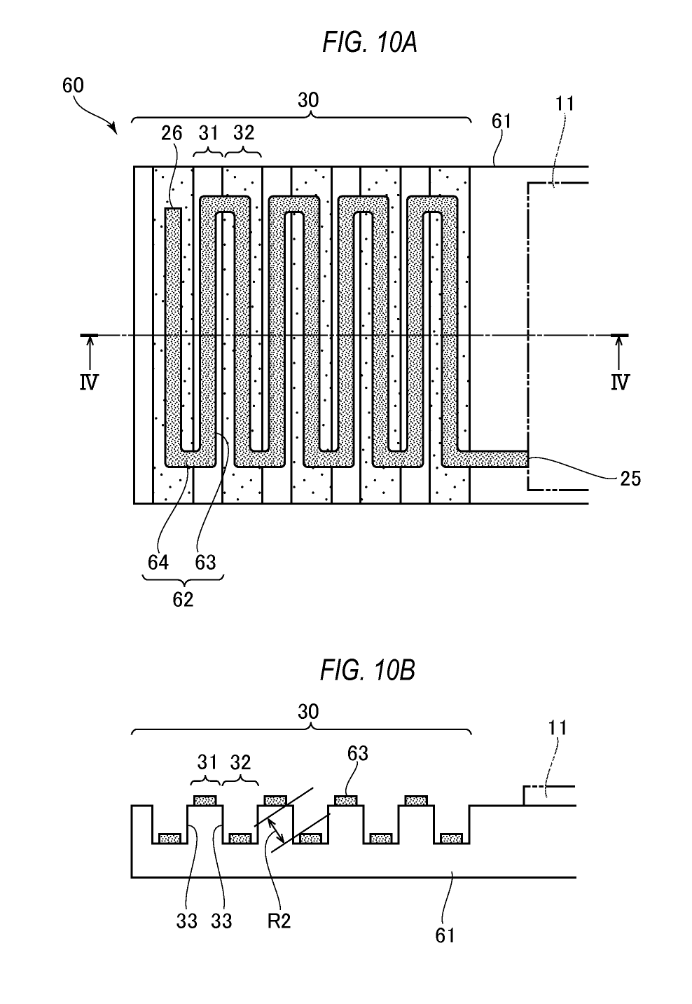

FIG. 10A is a plan view illustrating an antenna unit 60 of the present embodiment. FIG. 10B is sectional view of a IV-IV line illustrated in FIG. 10A. The same configurations as in the first embodiment are provided with the same reference numerals, and the description will not be repeated. The solder resist is not illustrated.

An antenna conductor 62 of the present embodiment is formed in a meandering shape by meandering width portions 63 and meandering extension portions 64. The meandering width portions 63 are alternately formed on flat surfaces that are top portions of the projections 31 and on flat surfaces that are bottom portions of the recesses 32. The meandering extension portions 64 are formed through the boundary portions 33.

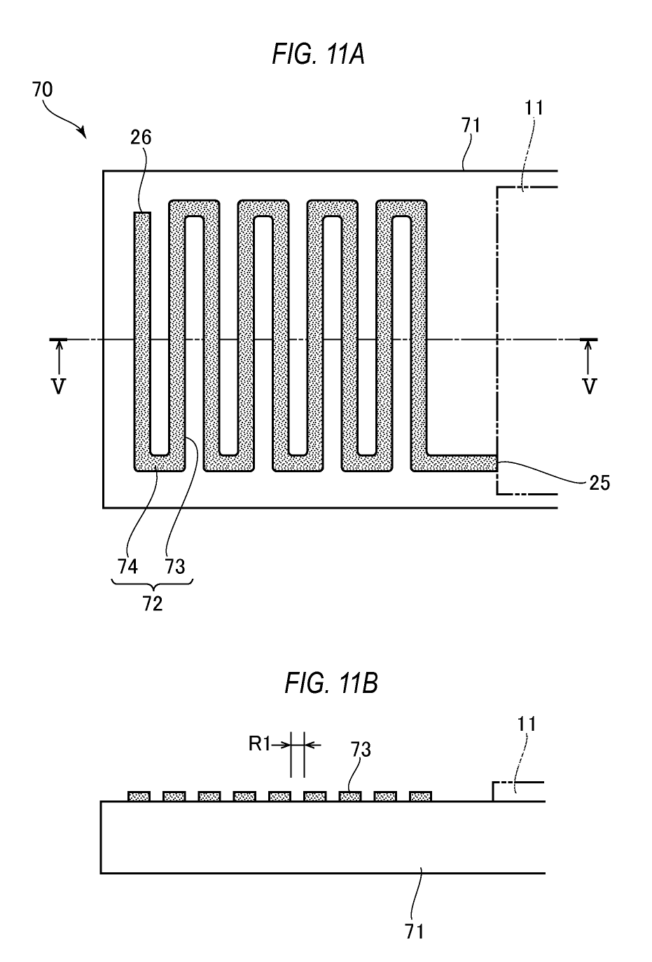

Meanwhile, FIG. 11A is a plan view illustrating an antenna unit 70 of a comparison mode. FIG. 11B is a sectional view of a V-V line illustrated in FIG. 11A. An antenna conductor 72 of the comparison mode is formed in a meandering shape by meandering width portions 73 and meandering extension portions 74. The meandering width portions 73 and the meandering extension portions 74 are alternately formed on a flat surface of the resin substrate 71.

The interval (R2 illustrated in FIG. 10B) between adjacent meandering width portions 63 in the present embodiment and the interval (R1 illustrated in FIG. 11B) between adjacent meandering width portions 73 in the comparison mode will be compared. The interval R2 between the meandering width portions 63 in the present embodiment is wider than the interval R1 between the meandering width portions 73 in the comparison mode, because the meandering width portions 63 are also separated in the thickness direction of the resin substrate 61. Therefore, as in the case in which the antenna conductor 22 is formed on the projections and recesses 30 in the sine wave shape of the first embodiment, the capacitive coupling caused by the reduction in the interval between adjacent conductors can be suppressed, and as a result, the area of the antenna conductor 62 on the substrate can be reduced.

The meandering width portions 63 may be formed not only on the flat surfaces, but also across part of vertical surfaces from the flat surfaces.

Other embodiments of forming the antenna conductor on the top portion of the projection 31 and the bottom portion of the recess 32 will be described in third to seventh embodiments. The same configurations as in the first embodiment are designated with the same reference numerals, and the description will not be repeated. The solder resist is not illustrated.

### Third Embodiment

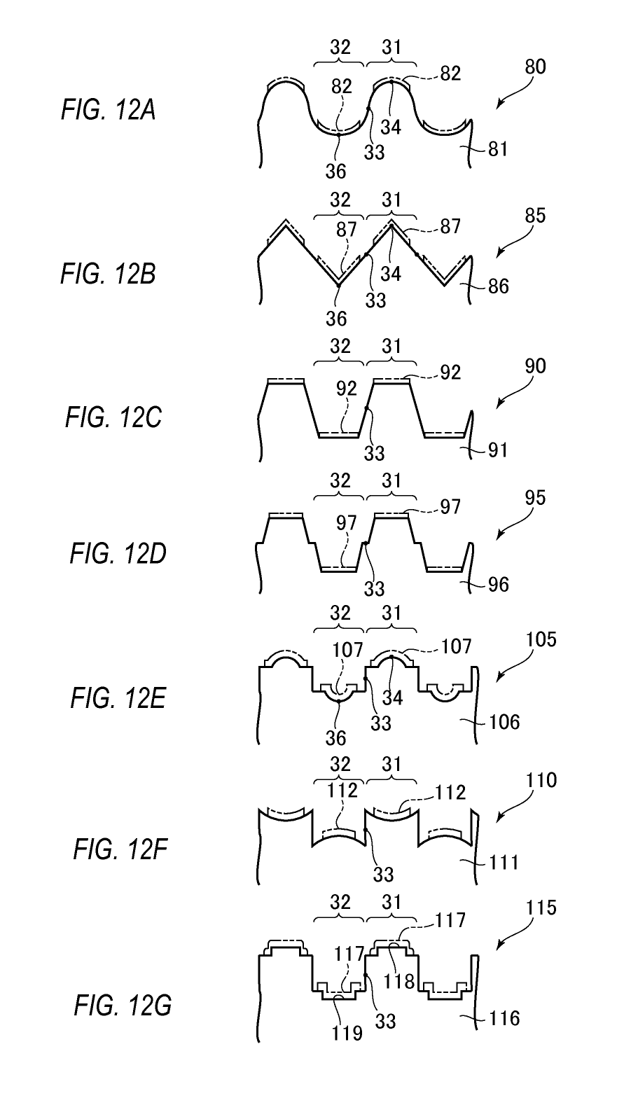

FIG. 12A is a sectional view of an antenna unit 80 according to a third embodiment. The projection 31 and the recess 32 of a resin substrate 81 are semicircular. Meandering width portions 82 of the antenna conductor of the present embodiment are formed throughout the inclined surfaces on both sides from the uppermost portion 34 of the projection 31 and throughout the inclined surfaces on both sides from the lowermost portion 36 of the recess 32.

### Fourth Embodiment

FIG. 12B is a sectional view of an antenna unit 85 according to a fourth embodiment. The projection 31 and the recess 32 of a resin substrate 86 are triangular. Meandering width portions 87 of the antenna conductor are also formed throughout the inclined surfaces on both sides from the uppermost portion 34 of the projection 31 and throughout the inclined surfaces on both sides from the lowermost portion 36 of the recess 32 in the present embodiment.

### Fifth Embodiment

FIG. 12C is a sectional view of an antenna unit 90 according to a fifth embodiment. The projection 31 and the recess 32 of a resin substrate 91 are trapezoidal. Meandering width portions 92 of the antenna conductor of the present embodiment are formed on the flat surface of the projection 31 and on the flat surface of the recess 32. In this way, the interval between the meandering width portions 92 can be wide even if the projection 31 and the recess 32 are trapezoidal, because the meandering width portions 92 are separated in the thickness direction of the resin substrate 91.

The meandering width portions 92 may be formed not only on the flat surfaces, but also across part of the inclined surfaces from the flat surfaces.

### Sixth Embodiment

FIG. 12D is a sectional view of an antenna unit 95 according to a sixth embodiment. The projection 31 and the recess 32 of a resin substrate 96 are trapezoidal, and the boundary portion 33 is flat. Meandering width portions 97 of the antenna conductor of the present embodiment are formed on the flat surface of the projection 31 and on the flat surface of the recess 32.

The meandering width portions 97 may be formed not only on the flat surfaces, but also across part of the inclined surfaces from the flat surfaces.

### Seventh Embodiment

FIG. 12E is a sectional view of an antenna unit 105 according to a seventh embodiment. The basic shapes of the projection 31 and the recess 32 of a resin substrate 106 are rectangular. The center of the projection 31 protrudes in a semicircular shape, and the center of the recess 32 is recessed in a semicircular shape. Meandering width portions 107 of the antenna conductor of the present embodiment are formed from the uppermost portion 34 of the projection 31 to part of the flat surface beyond the inclined surfaces on both sides and from the lowermost portion 36 of the recess 32 to part of the flat surface beyond the inclined surfaces on both sides.

### Eighth Embodiment

FIG. 12F is a sectional view of an antenna unit 110 according to an eighth embodiment. The top portion of the projection 31 of a resin substrate 111 as a whole is recessed downward in a curved shape, and the bottom portion of the recess 32 as a whole protrudes upward in a curved shape. Meandering width portions 112 of the antenna conductor of the present embodiment are formed throughout the inclined surface of the projection 31 and throughout the inclined surface of the recess 32.

### Ninth Embodiment

FIG. 12G is a sectional view of an antenna unit 115 according to a ninth embodiment. The basic shapes of the projection 31 and the recess 32 of a resin substrate 116 are rectangular. The projection 31 includes a rectangular portion 118 in which the center further protrudes in a rectangular shape, and the recess 32 includes a rectangular portion 119 in which the center is further recessed in a rectangular shape. Meandering width portions 117 of the antenna conductor of the present embodiment are formed to cover the rectangular portion 118 of the projection 31 and to cover the rectangular portion 119 of the recess 32.

### Tenth Embodiment

Although only one set of the projections and recesses 30 of the resin substrate is formed in the description of the first to ninth embodiments, a plurality of sets of projections and recesses are formed on a resin substrate 101 in the description of the present embodiment. The same components as in the first embodiment are provided with the same reference numerals, and the description will not be repeated. The solder resist is not illustrated. The circuits and the like mounted on the mounting section 11 are not illustrated.

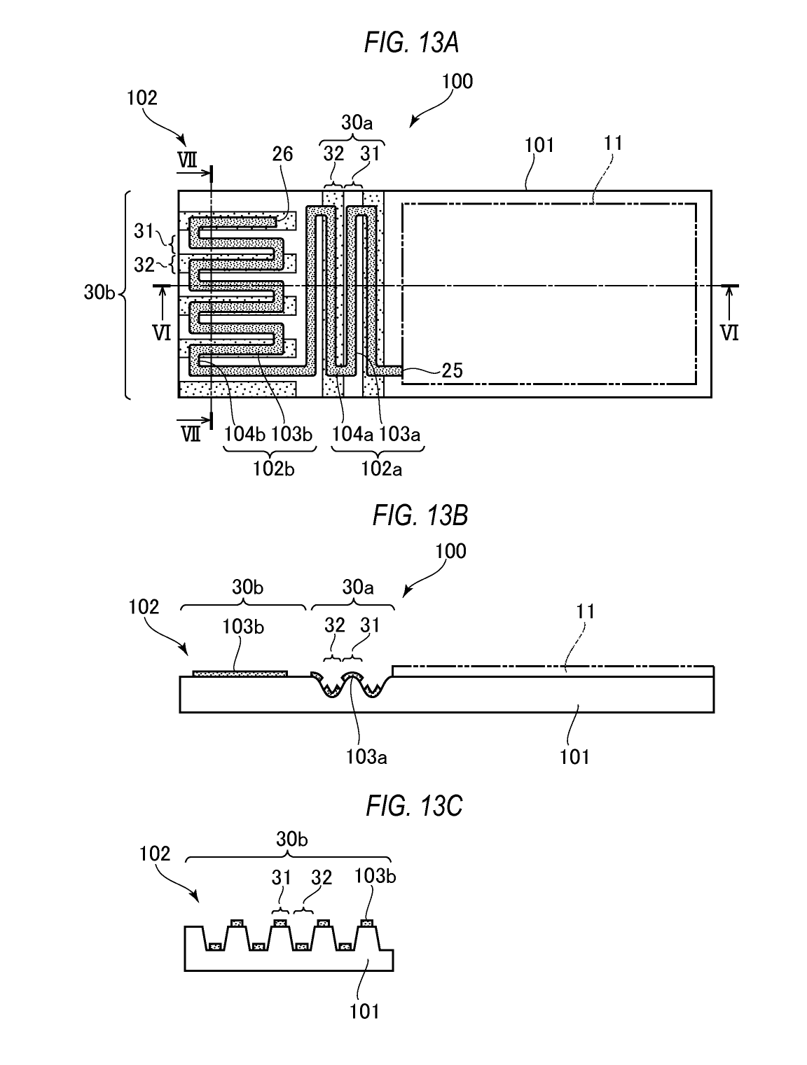

FIG. 13A is a plan view illustrating an antenna unit 100 of the present embodiment. FIG. 13B is a sectional view of a VI-VI line illustrated in FIG. 13A. FIG. 13C is a sectional view of a VII-VII line illustrated in FIG. 13A.

As illustrated in FIG. 13A, the resin substrate 101 of the present embodiment is provided with first projections and recesses 30a and second projections and recesses 30b in different projection and recess directions and in different cross section shapes. Specifically, the projection and recess direction of the projections 31 and the recesses 32 of the first projections and recesses 30a is the width direction of the resin substrate 101, and the cross section shape is a sine wave shape (see FIG. 13B). Meanwhile, the projection and recess direction of the projections 31 and the recesses 32 of the second projections and recesses 30b is the length direction of the resin substrate 101, and the cross section shape is trapezoidal (see FIG. 13C).

An antenna conductor 102 of the present embodiment includes a first antenna conductor 102a formed on the first projections and recesses 30a and a second antenna conductor 102b formed on the second projections and recesses 30b. The antenna conductor 102 is formed from the feeding portion 25 to the tip portion 26 through the first antenna conductor 102a and the second antenna conductor 102b.

In the first antenna conductor 102a of the present embodiment, meandering width portions 103a are alternately formed along the projections 31 and the recesses 32 of the first projections and recesses 30a, and meandering extension portions 104a connect adjacent meandering width portions 103a. Therefore, the first antenna conductor 102a is folded back from the meandering width portions 103a through the meandering extension portions 104a to meander and extend in the length direction of the resin substrate 101.

Meanwhile, in the second antenna conductor 102b of the present embodiment, meandering width portions 103b are alternately formed along the projections 31 and the recesses 32 of the second projections and recesses 30b, and meandering extension portions 104b connect adjacent meandering width portions 103b. Therefore, the second antenna conductor 102b is folded back from the meandering width portions 103b through the meandering extension portions 104b to meander and extend in the width direction of the resin substrate 101.

In this way, a plurality of sets of projections and recesses 30 can be formed on the resin substrate 101 to form the projections and recesses 30 at, for example, separate positions in the resin substrate 101. Therefore, the antenna conductors can also be freely set at separate positions according to the projections and recesses 30. Therefore, the antenna conductors can be formed at various positions even if, for example, the resin substrate 101 has a special shape. As a result, the space of the resin substrate 101 can be effectively used, and the wireless communication module 10 can be further downsized. The plurality of projections and recesses 30 may be formed not only in different projection and recess directions and different cross section shapes, but also in the same projection and recess direction and the same cross section shape.

### Eleventh Embodiment

The present embodiment provides: an electromagnetic-induction antenna apparatus that can perform at least one of transmission and reception of data; and an RFID system 201 as a communication system provided with the antenna apparatus.

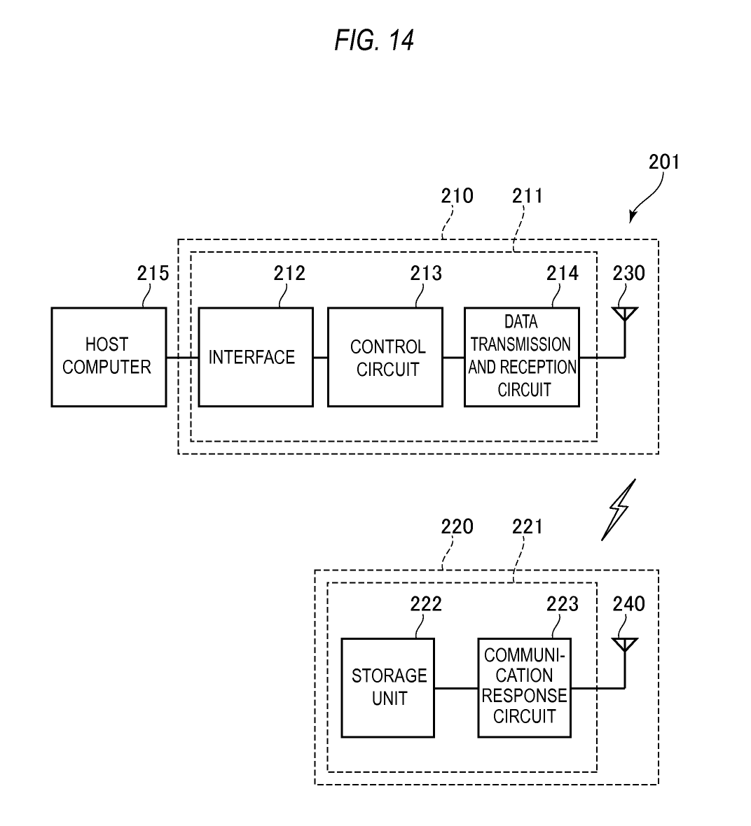

FIG. 14 is a view illustrating an example of a configuration of the RFID system 201.

The RFID system 201 includes: a reader/writer apparatus 210 that is a wireless communication apparatus which is an electronic device; and an IC card 220 that is a wireless communication medium which is an electronic device.

The reader/writer apparatus 210 reads data stored in an IC card 220 in a non-contact manner and writes data in the IC card 220. The reader/writer apparatus 210 includes a control unit 211 and an antenna unit 230 that functions as an antenna apparatus. The control unit 211 includes an interface 212, a control circuit 213, and a data transmission and reception circuit 214 (a communication circuit). The interface 212 inputs and outputs data signals to and from a host computer 215 connected to be able to communicate with the reader/writer apparatus 210. The control circuit 213 controls the entire reader/writer apparatus 210 according to an instruction of the host computer 215. The data transmission and reception circuit 214 modulates a data signal input by the host computer 215 through the interface 212 to convert the data signal to a transmission signal. The data transmission and reception circuit 214 demodulates a reception signal received by the antenna unit 230 to convert the reception signal to a data signal. The antenna unit 230 is formed in a coil shape as described later to generate a magnetic flux toward an antenna unit 240 of the IC card 220.

The host computer 215 is an information processing apparatus that transmits and receives data signals to and from the reader/writer apparatus 210.

The IC card 220 transmits and receives data to and from the reader/writer apparatus 210 in a non-contact manner. The IC card 220 includes a control unit 221 and the antenna unit 240 that functions as an antenna apparatus. The control unit 221 includes a storage unit 222 and a communication response circuit 223. The storage unit 222 stores received data, ID information, and the like. The antenna unit 240 is formed in a coil shape as described later and does not include a power supply. Therefore, the IC card 220 is a so-called passive type. The antenna unit 240 receives a magnetic flux from the reader/writer apparatus 210 to generate an induction voltage by electromagnetic induction to drive the control unit 221. Specifically, the communication response circuit 223 receives a transmission signal from the reader/writer apparatus 210 to perform communication in response to the transmission signal.

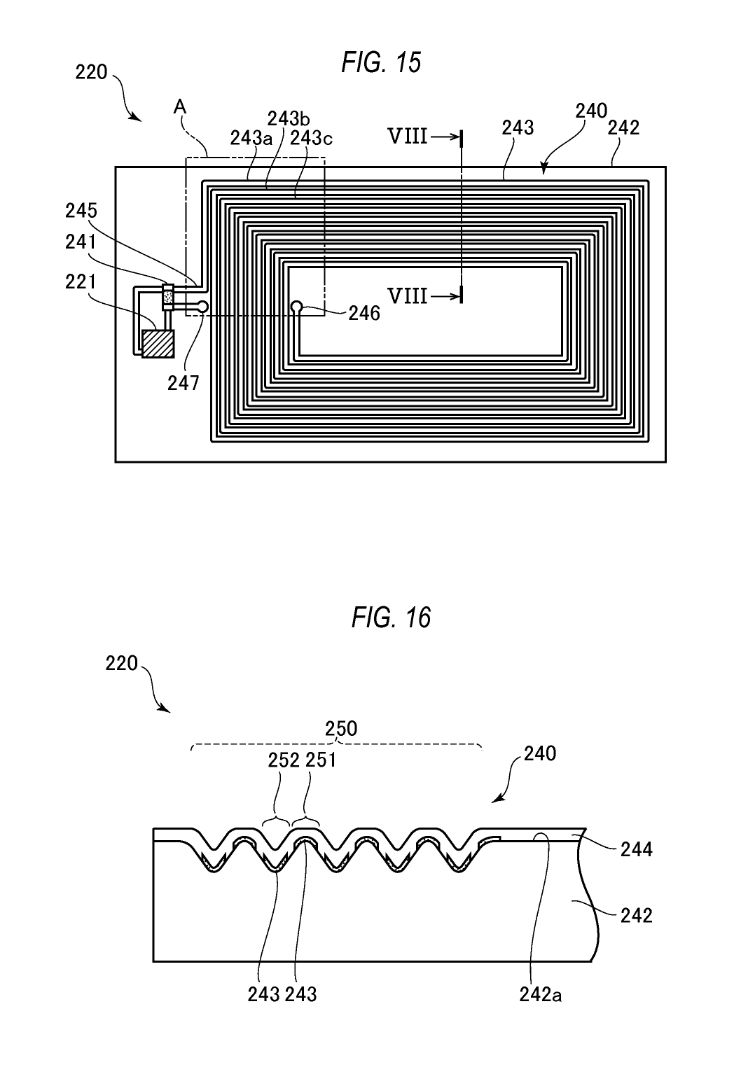

A configuration of the antenna unit 240 of the present embodiment will be described with reference to FIGS. 15 to 17. Although the antenna unit 240 of the IC card 220 will be described here, the antenna unit 230 of the reader/writer apparatus 210 can also have the same configuration.

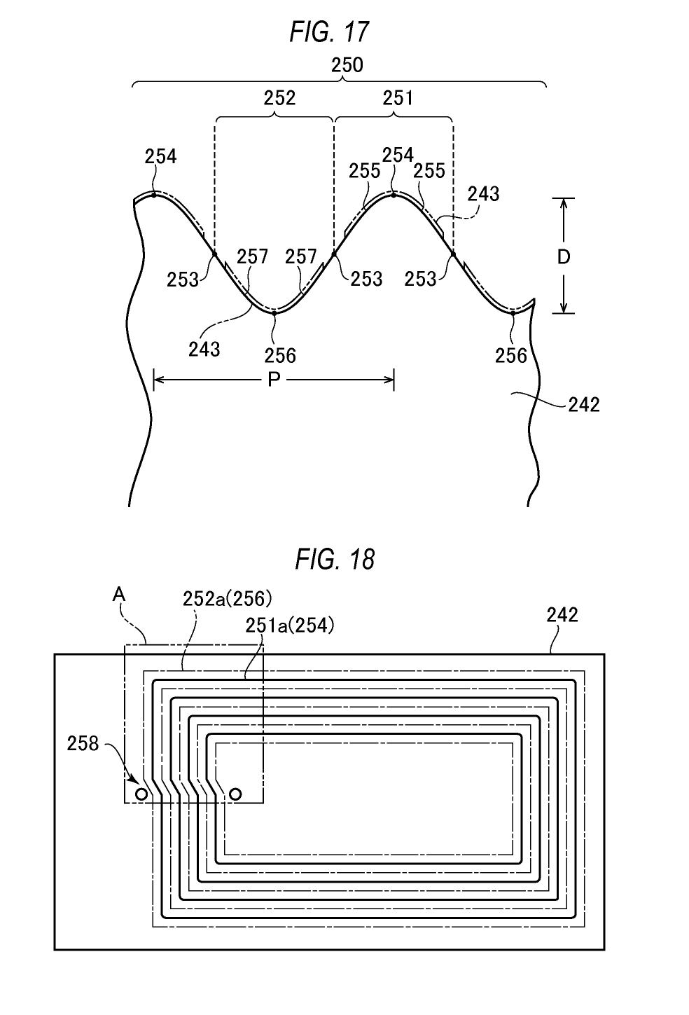

FIG. 15 is a plan view of the IC card 220. FIG. 16 is a partial sectional view of the IC card 220. FIG. 17 is an enlarged sectional view of a resin substrate 242 illustrated in FIG. 16.

As illustrated in FIG. 15, the IC card 220 includes the control unit 221, the antenna unit 240, and a capacitor 241 for resonance. The control unit 221, the antenna unit 240, and the capacitor 241 for resonance are arranged on the resin substrate 242 that is a base material. The control unit 221 includes an IC chip and is mounted on an end portion of the resin substrate 242. In the antenna unit 240, an antenna conductor 243 is formed in a coil shape on the resin substrate 242.

FIG. 16 is a sectional view of a VIII-VIII line illustrated in FIG. 15. As illustrated in FIG. 16, the resin substrate 242, the antenna conductor 243, and a solder resist 244 are sequentially laminated on the antenna unit 240 in this order. In the present embodiment, the antenna conductor 243 is three-dimensionally formed in the thickness direction of the resin substrate 242 (vertical direction illustrated in FIG. 16) to substantially increase the line width of the antenna conductor 243 to reduce the resistance of the antenna unit 240.

Specifically, projections and recesses 250 are formed on the upper surface of the resin substrate 242 as illustrated in FIG. 16. In the projections and recesses 250, projections 251 and recesses 252 are alternately formed in a direction of a mounting surface 242a orthogonal to the thickness direction of the resin substrate 242.

As illustrated in FIG. 17, the projections and recesses 250 of the present embodiment have a so-called sine wave shape, and the same shape is formed at each pitch P in the direction of the mounting surface. Top portions of the projections 251 and bottom portions of the recesses 252 are curved. More specifically, inclined surfaces 255 inclined from an uppermost portion 254 toward adjacent recesses 252 are formed on the projection 251. Similarly, inclined surfaces 257 inclined from a lowermost portion 256 toward adjacent projections 251 are formed on the recess 252. In the projections and recesses 250, a position at the middle of the depth D from the projection 251 to the recess 252 is a boundary portion 253 of the projection 251 and the recess 252. In the present embodiment, the boundary portion 253 is an intermediate position between the uppermost portion 254 and the lowermost portion 256. The boundary portion 253 of the present embodiment is inclined in the thickness direction with respect to the mounting surface 242a of the resin substrate 242. Therefore, the surface of the boundary portion 253 is exposed in plan view, and the boundary portion 253 can be recognized from the upper surface.

FIG. 18 is a plan view illustrating the resin substrate 242. The projections and recesses 250 are formed on the upper surface of the resin substrate 242. Here, solid lines indicate the uppermost portions 254 of the projections 251, and alternate short and long dash lines indicate the lowermost portions 256 of the recesses 252. As illustrated in FIG. 18, the projections 251 and the recesses 252 are alternately wound and formed in independent annular shapes with different sizes. Specifically, an outermost recess 252a has the largest rectangular annular shape, and a projection 251a positioned inside of the recess 252a has a rectangular annular shape smaller than the recess 252a. From there, the projections 251 and the recesses 252 are alternately arranged inward, and smaller rectangular shapes are formed at inner positions.

The antenna conductor 243 will be described with reference again to FIGS. 16 and 17. In FIG. 17, alternate long and two short dashes lines indicate the antenna conductor 243. The antenna conductor 243 of the present embodiment is formed on the top portions (upper surfaces) of the projections 251 and the bottom portions (upper surfaces) of the recesses 252. More specifically, the antenna conductor 243 is formed from the uppermost portion 254 throughout the inclined surfaces 255 on both sides in the projection 251 and from the lowermost portion 256 throughout the inclined surfaces 257 on both sides in the recess 252. The antenna conductor 243 is not formed in a predetermined range from the boundary portion 253 toward the projection 251 side and a predetermined range from the boundary portion 253 toward the recess 252 side, and a gap is formed between the antenna conductor 243 formed on the projection 251 and the antenna conductor 243 formed on the recess 252.

As illustrated in FIG. 15, the antenna conductor 243 is formed in a spiral shape along the top portions of the projections 251 and the bottom portions of the recesses 252. As illustrated in plan view of FIG. 15, the spiral shape here denotes a shape with one or more continuous circles, the size of each circle gradually decreasing. In FIG. 15, the antenna conductor 243 is formed in a spiral shape from one end 245 on the outside to another end 246 on the inside.

The other end 246 of the antenna conductor 243 and one end 247 of a conductor extending from the control unit 221 are electrically connected through a wiring pattern wired on the back side of the resin substrate 242.

In this way, the antenna conductor 243 is formed on the top portions of the projections 251 and the bottom portions of the recesses 252, and the antenna conductor 243 can be formed in the thickness direction of the resin substrate 242 because the top portions of the projections 251 and the bottom portions of the recesses 252 are inclined. Therefore, the line width of the antenna conductor 243 can be substantially increased, and the resistance of the antenna conductor 243 is reduced. This increases the induction voltage obtained by the antenna unit 240, and the antenna unit 240 can be downsized. Although the line width of the antenna conductor 243 is substantially wide, the line width (projection line width) of the antenna conductor 243 viewed from above is narrow. Therefore, an increase in the size of the resin substrate 242 can be prevented.

In the present embodiment, the antenna conductor 243 is alternately formed circle-by-circle on the top portions of the projections 251 and the bottom portions of the recesses 252 in the spiral shape from the one end 245 on the outside to the other end 246 on the inside. Specifically, as illustrated in FIG. 15, an antenna conductor 243a of the first circle from the one end 245 is formed on the bottom portion of the recess 252, and an antenna conductor 243b of the second circle is formed on the top portion of the projection 251. An antenna conductor 243c of the third circle is formed on the bottom portion of the recess 252, and from there, the antenna conductor is alternately formed in the same way. In this way, the antenna conductor 243 is switched at each circle from the projection 251 to the recess 252 or from the recess 252 to the projection 251, and the antenna conductor 243 passes through the boundary portion 253 of the projections and recesses 250 at each circle.

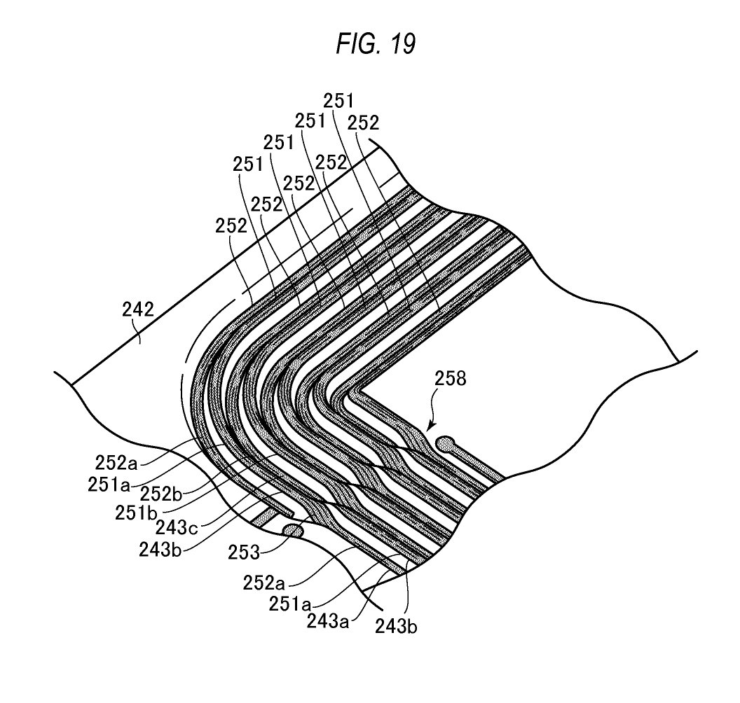

The state of the antenna conductor 243 switched between the projections 251 and the recesses 252 will be described with reference to FIG. 19. FIG. 19 is a perspective view of a section A illustrated in FIGS. 15 and 18. As illustrated in FIG. 19, each projection 251 and each recess 252 of the resin substrate 242 are provided with a transition portion 258 at a position of the end of one circle and the start of the next circle of the antenna conductor 243.

The transition portion 258 is inclined toward the position of the start of the outside circle of the antenna conductor 243 at each cycle in plan view. Therefore, focusing on the antenna conductor 243a of the first circle and the antenna conductor 243b of the second circle for example, the antenna conductor 243 is switched from the bottom portion of the recess 252a to the top portion of the projection 251a through the boundary portion 253 of the transition portion 258. Similarly, focusing on the antenna conductor 243b of the second circle and the antenna conductor 243c of the third circle, the antenna conductor 243 is switched from the top portion of the projection 251a to the bottom portion of a recess 252b through the boundary portion 253.

In this way, the transition portion 258 can be formed at the position of the end of each circle and the start of the next circle of the antenna conductor 243 in the projections and recesses 250 to alternately form, circle-by-circle, the antenna conductor 243 on the bottom portion of the recess 252 and the top portion of the projection 251. The alternate formation of the antenna conductor 243 on the top portion of the projection 251 and the bottom portion of the recess 252 at each circle can narrow down the lines of adjacent antenna conductors 243, and an increase in the size of the resin substrate 242 can be prevented.

The transition portion 258 is inclined toward the position of the start of the outside circle of the antenna conductor 243 in plan view, and the antenna conductor 243 is switched between the top portion of the projection 251 and the bottom portion of the recess 252 at the position of the transition portion 258 just by simple linear formation of the antenna conductor 243.

The transition portion 258 may not be inclined toward the position of the start of the outside circle, but may be inclined toward the position of the start of the inside circle.

Instead of forming the transition portion 258 on the projections and recesses 250, the antenna conductor 243 may be just linear. In this case, the antenna conductor 243 can pass through the boundary portion 253 at an angle in plan view, and the antenna conductor 243 can be switched from the bottom portion of the recess 252 to the top portion of the projection 251 or from the top portion of the projection 251 to the bottom portion of the recess 252.

A method of manufacturing the IC card 220 or the reader/writer apparatus 210 including the antenna unit 240 will be described.

First, the resin substrate 242 provided with the projections and recesses 250 is manufactured. Specifically, a molten resin is extruded to mold a molten resin sheet, and before the molded molten resin sheet is cured, the sheet is pressured by a mirror surface roll and a resin roll, which includes a peripheral surface covered by a resin, to form a resin sheet. In the formed resin sheet, a photocurable resin composition layer is formed on the upper surface of the surface pressed against the resin roll, and the projections and recesses 250 are formed on the formed photocurable resin composition layer. A thermoplastic polyimide resin is used for the molten resin, and a photocurable polyimide resin is used for the photocurable resin composition. The thickness of the resin sheet is 1 mm.

The resin sheet provided with the projections and recesses 250 is cut into a size manageable in subsequent steps, such as 250 mm×300 mm. Subsequently, a boring process is applied to the cut resin sheet. A copper thin film is formed on the entire front and back surfaces of the resin sheet and on a hole inner wall surface by electroless plating, and then a copper foil is formed at a thickness of 25 μm by electrolytic plating. Subsequently, a photoresist is applied, and a mask with the antenna conductor pattern and the wiring pattern of the control unit 221 is used to perform UV exposure. A resist pattern is formed on the copper foil by development, and etching is performed by a ferric chloride aqueous solution.

The resist is peeled off by a peeling solution. A solder resist layer may be formed over the copper foil to protect the copper foil. In this case, a screen mask can be used to form a film on the entire surface, and a mask with a solder resist pattern can be used to perform UV exposure. A solder resist of a necessary part of the mounting section can be opened by a developer. The resin sheet can be cut for each repeated pattern to manufacture individual resin substrates. Lastly, the control unit 221 and the capacitor 241 for resonance that are necessary electronic components can be mounted on the mounting surface 242a of the manufactured resin substrate 242 to manufacture the IC card 220 or the reader/writer apparatus 210.

In the formation of the antenna conductor 243 on the boundary portion 253 of the transition portion 258, the copper foil can be easily formed because the boundary portion 253 is inclined, and the surface of the boundary portion 253 is exposed in plan view in the present embodiment.

Impedance of an antenna unit 260 of an example with the configuration described above and impedance of an antenna unit 270 of a comparative example are analyzed by an electromagnetic field simulator.

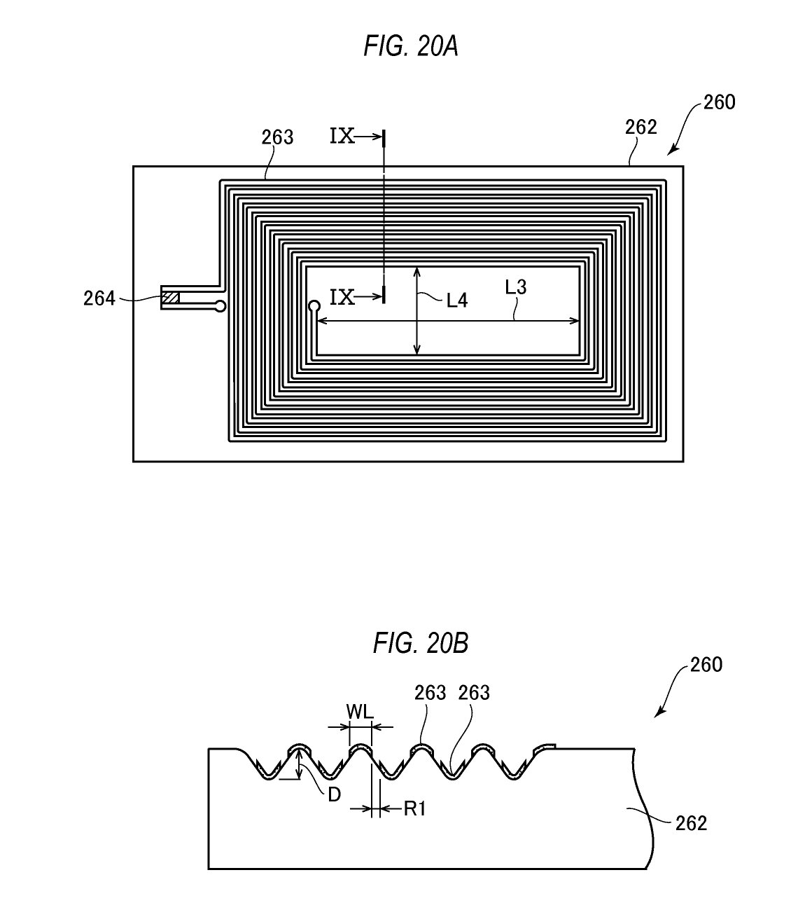

The dimension and the like of the antenna unit 260 of the example will be described with reference to FIGS. 20A and 20B. FIG. 20A is a plan view of the antenna unit 260 of the example. FIG. 20B is a sectional view of a IX-IX line illustrated in FIG. 20A.

In the example, the projections and recesses 250 of the resin substrate 262 are formed in a sine wave shape. A polyimide resin is used for the resin substrate 262, and the depth D from the projection 251 to the recess 252 is 0.2 mm. As for the dimensions in plan view, the line width WL of the antenna conductor 263 is 0.2 mm, and the interval R1 between the antenna conductor 263 of the projection 251 and the antenna conductor 263 of the recess 252 is 0.05 mm. The antenna conductor 263 is a copper foil with a thickness of 25 The number of circles of the antenna conductor 263 is ten. A length L3 of the innermost circle of the antenna conductor 263 in the longitudinal direction is 20 mm, and a length L4 in the short direction is 10 mm. Modeling of the control unit 221 is difficult, and a port 264 is set in place of the control unit 221. For the convenience, the solder resist is not illustrated in FIG. 20B.

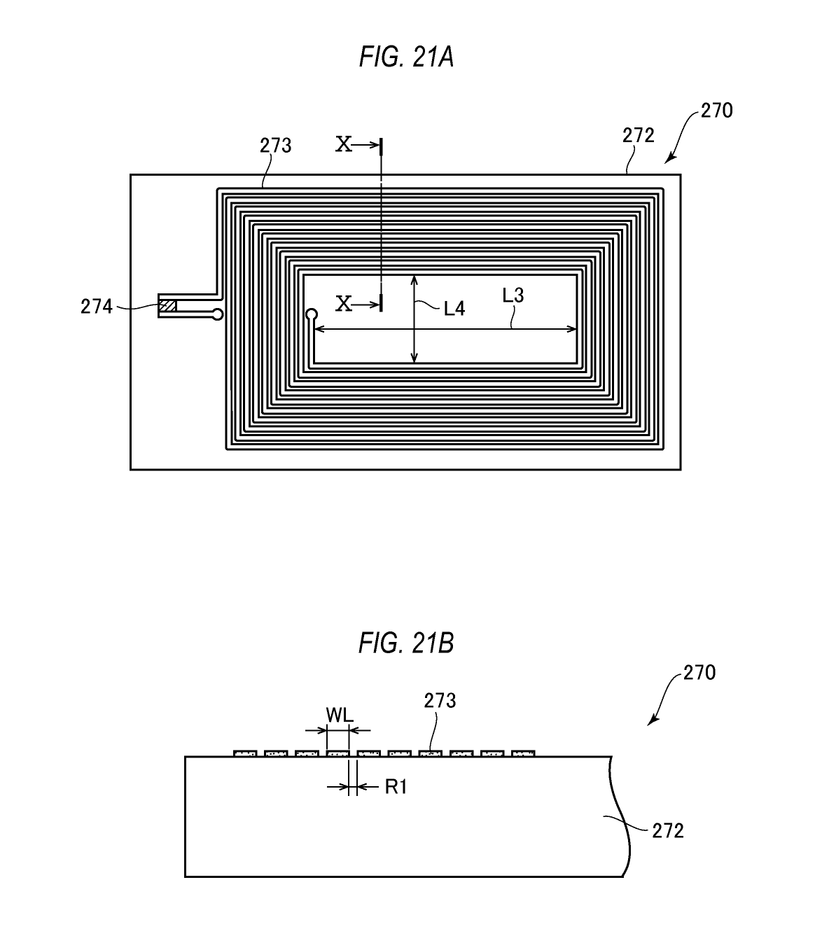

The dimension and the like of the antenna unit 270 of the comparative example will be described with reference to FIGS. 21A and 21B. FIG. 21A is a plan view of the antenna unit 270 of the comparative example. FIG. 21B is a sectional view of a X-X line illustrated in FIG. 21A.

In the comparative example, a polyimide resin is used for a resin substrate 272. As for the dimension in plan view, the line width WL of the antenna conductor 273 is 0.2 mm, and the interval R1 between the antenna conductors 273 is 0.05 mm. The antenna conductor 273 is a copper foil with a thickness of 25 μm. The number of circles of the antenna conductor 273 is ten. The length L3 of the innermost circle of the antenna conductor 273 in the longitudinal direction is 20 mm, and the length L4 in the short direction is 10 mm. A port 274 is set in place of the control unit 221. For the convenience, the solder resist is not illustrated in FIG. 21B.

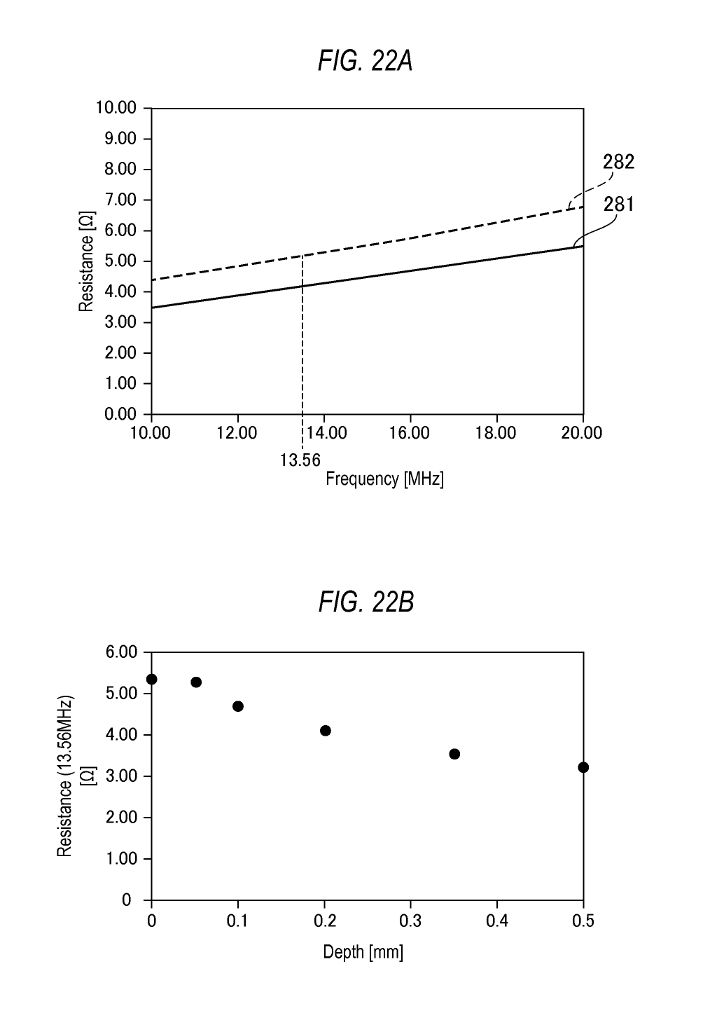

FIG. 22A is a diagram comparing resistance (real part of impedance) of the antenna unit 260 of the example and resistance of the antenna unit 270 of the comparative example. In FIG. 22A, the vertical axis indicates the resistance [Ω], and the horizontal axis indicates the frequency [MHz]. A solid line 281 indicates a characteristic line of the resistance of the antenna unit 260 in the example, and a dashed line 282 indicates a characteristic line of the resistance of the antenna unit 270 in the comparative example.

As illustrated in FIG. 22A, for example, the resistance of the antenna unit 270 of the comparative example is 5.3 [Ω] at frequency 13.56 [MHz], while the resistance of the antenna unit 260 of the example is 4.1 [Ω]. Therefore, it can be confirmed that the antenna unit 260 of the example can reduce the resistance by about 23% compared to the antenna unit 270 of the comparative example. As a result, the induction voltage obtained by the antenna unit 260 increases, and the antenna unit can be downsized.

FIG. 22B is a view illustrating a relationship between the depth D and a resistance reduction effect of the antenna unit 260 of the example. In FIG. 22B, the vertical axis indicates the resistance [Ω], and the horizontal axis indicates the depth D [mm]. The frequency is 13.56 [MHz].

As illustrated in FIG. 22B, it can be recognized that the resistance reduction effect increases with an increase in the depth D from depth 0 [mm] where the resistance is 5.3 [Ω] in the comparative example. When the depth D is 0.5 [mm], the resistance decreases to 3.3 [Ω]. Therefore, the downsizing effect increases with an increase in the depth D.

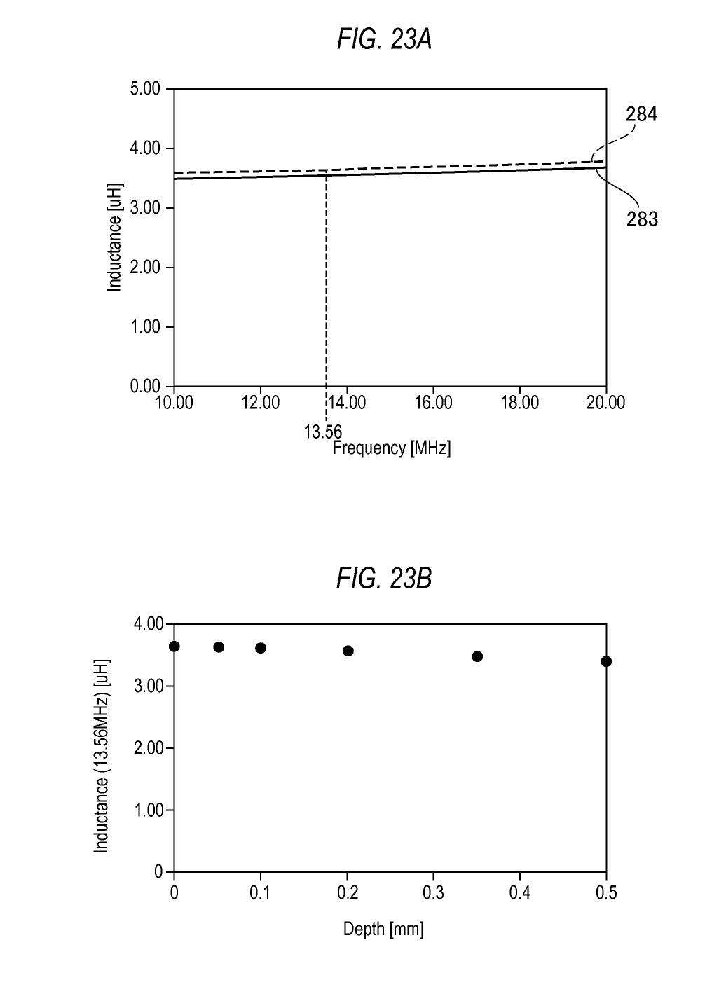

Meanwhile, FIG. 23A is a diagram comparing inductance of the antenna unit 260 of the example and inductance of the antenna unit 270 of the comparative example. In FIG. 23A, the vertical axis indicates the inductance [μH], and the horizontal axis indicates the frequency [MHz]. A solid line 283 indicates a characteristic line of the inductance of the antenna unit 260 in the example, and a dashed line 284 indicates a characteristic line of the inductance of the antenna unit 270 in the comparative example.

As illustrated in FIG. 23A, for example, the inductance of the antenna unit 270 of the comparative example is 3.6 [μH] at frequency 13.56 [MHz], and the inductance of the antenna unit 260 of the example is 3.5 [μH]. Therefore, the antenna unit 260 of the example and the antenna unit 270 of the comparative example have substantially the same inductance.

FIG. 23B is a view illustrating a relationship between the depth D and change in the inductance of the antenna unit 260 of the example. In FIG. 23B, the vertical axis indicates the inductance [μH], and the horizontal axis indicates the depth D [mm]. The frequency is 13.56 [MHz].

As illustrated in FIG. 23B, it can be recognized that the inductance hardly changes even if the depth D is deep. As described, while the inductance is 3.6 [μH] when the depth D is 0 [mm] which corresponds to the comparative example, the inductance is 3.5 [μH] when the depth D is 0.2 [mm].

Therefore, it can be confirmed in the present analysis that the antenna unit 260 of the example can be downsized while maintaining substantially the same inductance as that of the antenna unit 270 of the comparative example.

In this way, according to the present embodiment, the antenna conductor 243 is formed on the top portions of the projections 251 and the bottom portions of the recesses 252. Therefore, the substantial line width of the antenna conductor 243 can be increased without increasing the size of the resin substrate 242, and the resistance of the antenna conductor 243 can be reduced. Thus, the induction voltage obtained by the antenna unit 240 increases, and the antenna unit 240 can be downsized.

### Twelfth Embodiment

Although the transition portion 258 inclined toward the position of the start of the outside circle of the antenna conductor 243 has been described in the eleventh embodiment, a different transition portion will be described in the present embodiment. The configuration of forming the antenna conductor 243 on the top portions of the projections 251 and the bottom portions of the recesses 252 is the same as in FIGS. 16 and 17, and the description will not be repeated.

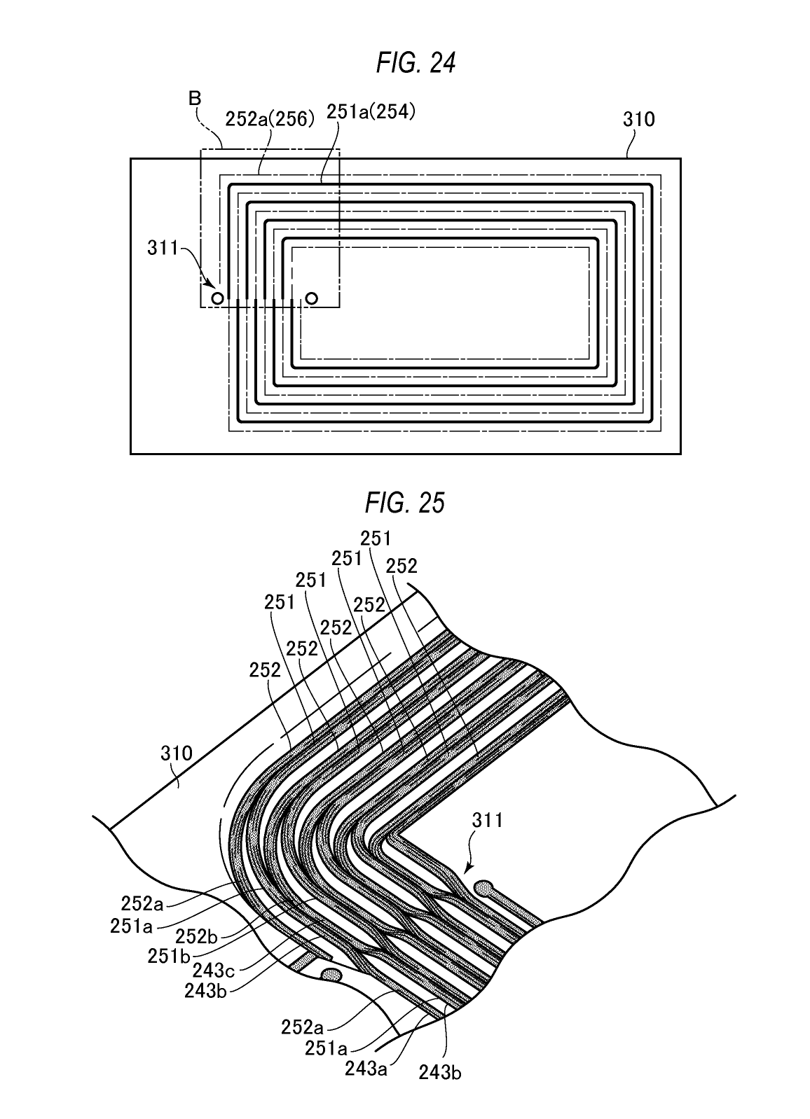

FIG. 24 is a plan view illustrating a resin substrate 310 of the present embodiment. The projections and recesses 250 are formed on the upper surface of the resin substrate 310. A solid line indicates the uppermost portion 254 of the projection 251, and an alternate short and long dash line indicates the lowermost portion 256 of the recess 252.

As illustrated in FIG. 24, the projections 251 and the recesses 252 are alternately wound and formed, cycle-by-cycle, in a spiral shape. Specifically, a transition portion 311 is formed to make a transition to the projection 251a in the second cycle when the outermost recess 252a makes one cycle. Subsequently, the recesses 252 and the projections 251 alternately make transitions, cycle-by-cycle, in the same way through the transition portion 311. A state of the antenna conductor 243 switched between the projections 251 and the recesses 252 will be described with reference to FIG. 25. FIG. 25 is a perspective view of a section B illustrated in FIG. 24.

As illustrated in FIG. 25, there is an inclination in the transition portion 311 in the thickness direction of the resin substrate 310 to make a transition from the projection 251 to the recess 252 or from the recess 252 to the projection 251. Therefore, in the present embodiment, the antenna conductor 243 is formed along the top portions of the projections 251 and the bottom portions of the recesses 252, and the antenna conductor 243 is alternately formed, circle-by-circle, on the top portions of the projections 251 and the bottom portions of the recesses 252.

In FIG. 25, focusing on the antenna conductor 243a of the first circle and the antenna conductor 243b of the second circle for example, the antenna conductor 243 is switched from the bottom portion of the recess 252a to the top portion of the projection 251a through the inclination of the transition portion 311. Similarly, focusing on the antenna conductor 243b of the second circle and the antenna conductor 243c of the third circle, the antenna conductor 243 is switched from the top portion of the projection 251a to the bottom portion of the recess 252b through the inclination of the transition portion 311.

Therefore, as in the eleventh embodiment, the substantial line width of the antenna conductor 243 can be increased without increasing the size of the resin substrate 310 in the present embodiment, and the resistance of the antenna conductor 243 can be reduced. This increases the dielectric voltage obtained by the antenna unit, and the antenna unit can be downsized.

Other embodiments for forming an antenna conductor on the top portions of the projections 251 and the bottom portions of the recesses 252 will be described with reference to thirteenth to twenty-fifth embodiments.

### Thirteenth Embodiment

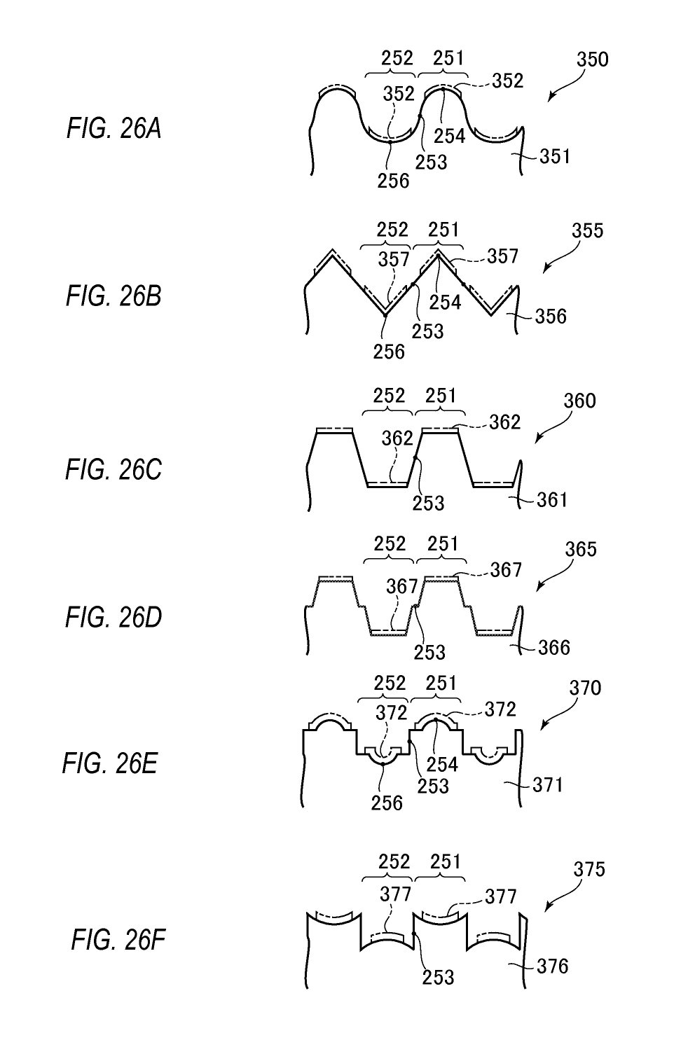

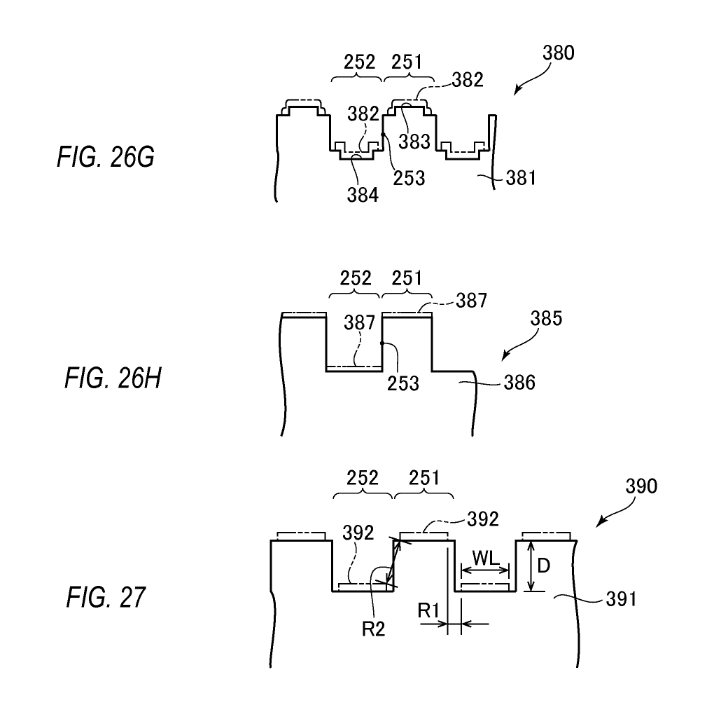

FIG. 26A is a sectional view of an antenna unit 350 according to a thirteenth embodiment. The projection 251 and the recess 252 of a resin substrate 351 are semicircular. The antenna conductor 352 of the present embodiment is formed from the uppermost portion 254 of the projection 251 throughout the inclined surfaces on both sides of the uppermost portion 254 and from the lowermost portion 256 of the recess 252 throughout the inclined surfaces on both sides.

### Fourteenth Embodiment

FIG. 26B is a sectional view of a resin substrate 355 according to a fourteenth embodiment. The projection 251 and the recess 252 of a resin substrate 356 are triangular. In the present embodiment, an antenna conductor 357 is also formed from the uppermost portion 254 of the projection 251 throughout the inclined surfaces on both sides and from the lowermost portion 256 of the recess 252 throughout the inclined surfaces on both sides.

### Fifteenth Embodiment

FIG. 26C is a sectional view of an antenna unit 360 according to a fifteenth embodiment. The projection 251 and the recess 252 of a resin substrate 361 are trapezoidal. An antenna conductor 362 of the present embodiment is formed on the flat surface of the projection 251 and on the flat surface of the recess 252. In this way, even if the projection 251 and the recess 252 are trapezoidal, the flat surfaces of the projection 251 and the recess 252 can be widened to reduce the resistance of the antenna conductor 362. Meanwhile, the distance between the lines of the antenna conductor 362 can be narrowed down in plan view, and an increase in the size of the resin substrate 361 can be prevented. The antenna conductor 362 may be formed not only on the flat surfaces, but also across part of the inclined surfaces from the flat surfaces.

### Sixteenth Embodiment

FIG. 26D is a sectional view of an antenna unit 365 according to a sixteenth embodiment. The projection 251 and the recess 252 of a resin substrate 366 are trapezoidal, and the boundary portion 253 is flat. An antenna conductor 367 of the present embodiment is formed on the flat surface of the projection 251 and the flat surface of the recess 252. The antenna conductor 367 may be formed not only on the flat surfaces, but also across part of the inclined surfaces from the flat surfaces.

### Seventeenth Embodiment

FIG. 26E is a sectional view of an antenna unit 370 according to a seventeenth embodiment. Basic shapes of the projection 251 and the recess 252 of a resin substrate 371 are rectangular. The center of the projection 251 protrudes in a semicircular shape, and the center of the recess 252 is recessed in a semicircular shape. An antenna conductor 372 of the present embodiment is formed from the uppermost portion 254 of the projection 251 to part of the flat surfaces beyond the inclined surfaces on both sides and from the lowermost portion 256 of the recess 252 to part of the flat surfaces beyond the inclined surfaces on both sides.

### Eighteenth Embodiment

FIG. 26F is a sectional view of an antenna unit 375 according to an eighteenth embodiment. The top portion of the projection 251 of a resin substrate 376 as a whole is recessed downward in a curved shape, and the bottom portion of the recess 252 as a whole protrudes upward in a curved shape. An antenna conductor 377 of the present embodiment is formed throughout the inclined surface of the projection 251 and throughout the inclined surface of the recess 252.

### Nineteenth Embodiment

FIG. 26G is a sectional view of an antenna unit 380 according to a nineteenth embodiment. The basic shapes of the projection 251 and the recess 252 of a resin substrate 381 are rectangular. The projection 251 includes a rectangular portion 383 in which the center further protrudes in a rectangular shape, and the recess 252 includes a rectangular portion 384 in which the center is further recessed in a rectangular shape. An antenna conductor 352 of the present embodiment is formed to cover the rectangular portion 383 of the projection 251 and to cover the rectangular portion 384 of the recess 252.

### Twentieth Embodiment

FIG. 26H is a sectional view of an antenna unit 385 according to a twentieth embodiment. The projection 251 and the recess 252 of a resin substrate 386 are rectangular. An antenna conductor 387 of the present embodiment is formed on the flat surface of the projection 251 and the flat surface of the recess 252. In this way, even if the projection 251 and the recess 252 are rectangular, the flat surfaces of the projection 251 and the recess 252 can be widened to reduce the resistance of the antenna conductor 387. Meanwhile, the distance between the lines of the antenna conductors 387 can be narrowed down in plan view, and an increase in the size of the resin substrate 386 can be prevented. The antenna conductor 387 may be formed not only on the flat surfaces, but also across part of the vertical surfaces.

### Twenty-First Embodiment

FIG. 27 is a sectional view of an antenna unit 390 according to a twenty-first embodiment. The projection 251 and the recess 252 of a resin substrate 391 are rectangular. An antenna conductor 392 of the present embodiment is formed on the flat surface of the projection 251 and the flat surface of the recess 252. Unlike the twentieth embodiment, the line width of the antenna conductor 392 is not wide in the present embodiment. Therefore, the antenna conductor 392 is alternately formed on the top portion of the projection 251 and the bottom portion of the recess 252 without changing the line width.

The impedance of the antenna unit 390 provided with the antenna conductor 392 alternately formed circle-by-circle on the rectangular projections 251 and recesses 252 without changing the line width as illustrated in FIG. 27 and the impedance of an antenna unit of the comparative example are analyzed by an electromagnetic field simulator.

In an example, a polyimide resin is used for the resin substrate 391, and the depth D from the projection 251 to the recess 252 is 0.2 mm as illustrated in FIG. 27. The line width WL of the antenna conductor 392 is 0.2 mm, and the interval R1 between the antenna conductors indicated by the dimension in plan view is 0.05 mm. The antenna conductor 392 is a copper foil with a thickness of 25 μm. The number of circles of the antenna conductor 392, the length L3 of the innermost circle of the antenna conductor 392 in the longitudinal direction, the length L4 in the short direction, and the like are the same as in FIG. 21A described above.

Meanwhile, the dimension and the like of the antenna unit of the comparative example are the same as in FIGS. 21A and 21B described above.

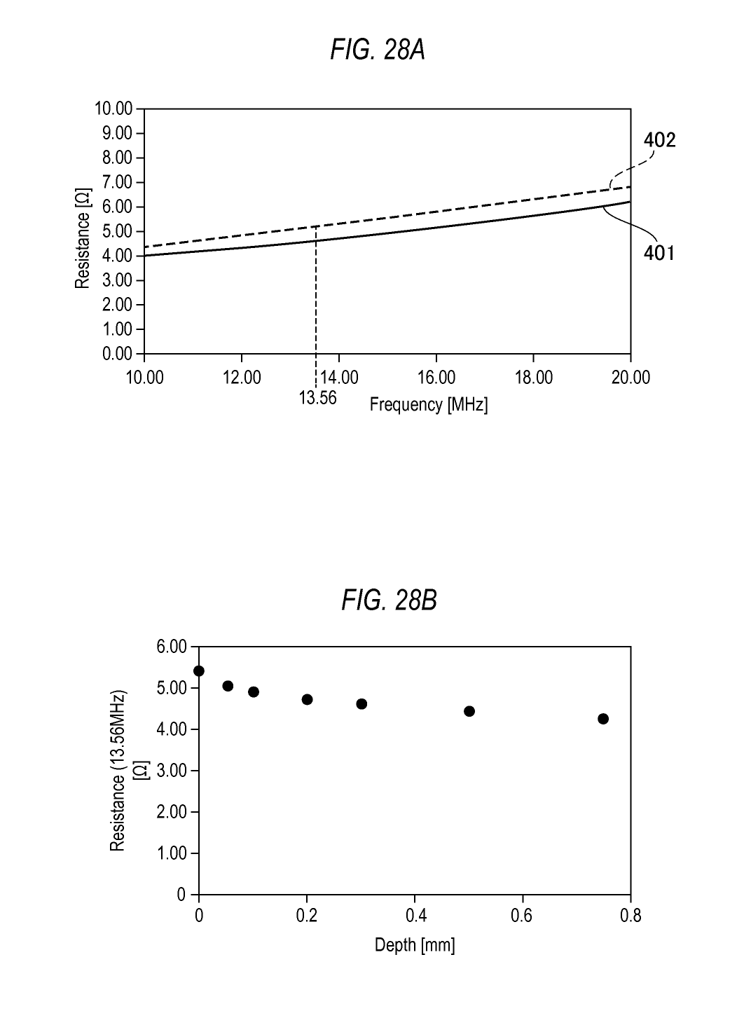

FIG. 28A is a diagram comparing the resistance (real part of impedance) of the antenna unit 390 of the example and the resistance of the antenna unit of the comparative example. In FIG. 28A, the vertical axis indicates the resistance [Ω], and the horizontal axis indicates the frequency [MHz]. A solid line 401 indicates a characteristic line of the resistance of the antenna unit 390 in the example, and a dashed line 402 indicates a characteristic line of the resistance of the antenna unit in the comparative example.

As illustrated in FIG. 28A, at frequency 13.56 [MHz] for example, the resistance of the antenna unit of the comparative example is 5.3 [Ω], while the resistance of the antenna unit 390 of the example is 4.7 [Ω]. Therefore, it can be confirmed that the antenna unit 390 of the example can reduce the resistance by about 11% compared to the antenna unit of the comparative example.

FIG. 28B is a view illustrating a relationship between the depth D and the resistance reduction effect of the antenna unit 390 of the example. In FIG. 28B, the vertical axis indicates the resistance [Ω], and the horizontal axis indicates the depth D [mm]. The frequency is 13.56 [MHz].

As illustrated in FIG. 28B, it can be recognized that the resistance reduction effect increases with an increase in the depth D from depth 0 [mm] where the resistance is 5.3 [Ω] in the comparative example. When the depth D is 0.75 [mm], the resistance decreases to 4.3 [Ω].

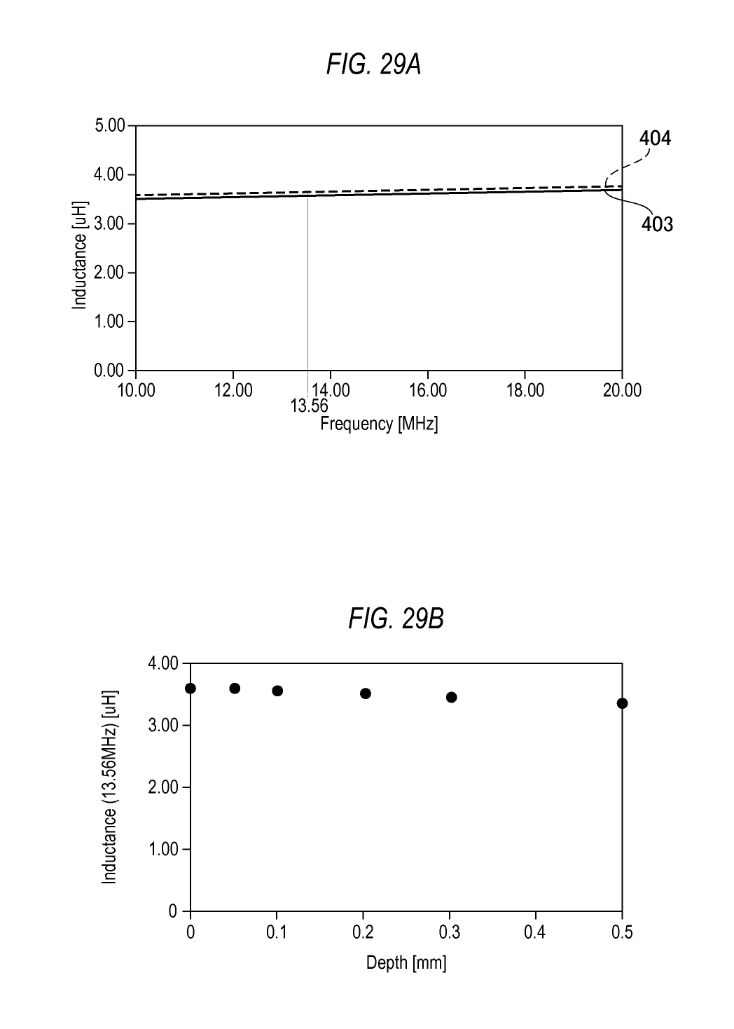

Meanwhile, FIG. 29A is a diagram comparing the inductance of the antenna unit 390 of the example and the inductance of the antenna unit of the comparative example. In FIG. 29A, the vertical axis indicates the inductance [μH], and the horizontal axis indicates the frequency [MHz]. A solid line 403 indicates a characteristic line of the inductance of the antenna unit 390 in the example, and a dashed line 404 indicates a characteristic line of the inductance of the antenna unit in the comparative example.

As illustrated in FIG. 29A, the inductance of the antenna unit of the comparative example is 3.6 [μH] at frequency 13.56 [MHz] for example, and the inductance of the antenna unit 390 of the example is 3.5 [μH]. Therefore, the antenna unit 390 of the example and the antenna unit of the comparative example have substantially the same inductance.

FIG. 29B is a view illustrating a relationship between the depth D and change in the inductance of the antenna unit 390 of the example. In FIG. 29B, the vertical axis indicates the inductance [μH], and the horizontal axis indicates the depth D [mm]. The frequency is 13.56 [MHz].

As illustrated in FIG. 29B, it can be recognized that the inductance hardly changes even if the depth D is deep. As described, while the inductance is 3.6 [μH] when the depth D is 0 [mm] which corresponds to the comparative example, the inductance is 3.5 [μH] when the depth D is 0.2 [mm].

In this way, according to the present embodiment, the antenna conductor can be formed on the top portions of the rectangular projections and the bottom portions of the recesses to reduce the resistance of the antenna conductor without increasing the size of the resin substrate. Therefore, the power loss in the antenna conductor can be reduced when the antenna unit is used in a reader/writer apparatus, and the amount of generated magnetic flux increases. As a result, the antenna can be downsized. The induction voltage increases when the antenna unit is used in an IC card, and the antenna can be downsized.

The resistance reduction effect is smaller than when the antenna conductor is formed on the top portions of the projections and the bottom portions of the recesses, and the top portions and the bottom portions are inclined, as in the eleventh embodiment. This is because the substantial line width is not large in the present embodiment. And yet, there is a resistance reduction effect because the substantial interval R2 is large as illustrated in FIG. 27. Therefore, the parasitic capacity is reduced, and the self-resonance frequency is shifted to high frequency. Thus, to obtain a large resistance reduction effect, it is desirable to use a resin substrate in which the top portions of the projections and the bottom portions of the recesses are inclined.

### Twenty-Second Embodiment

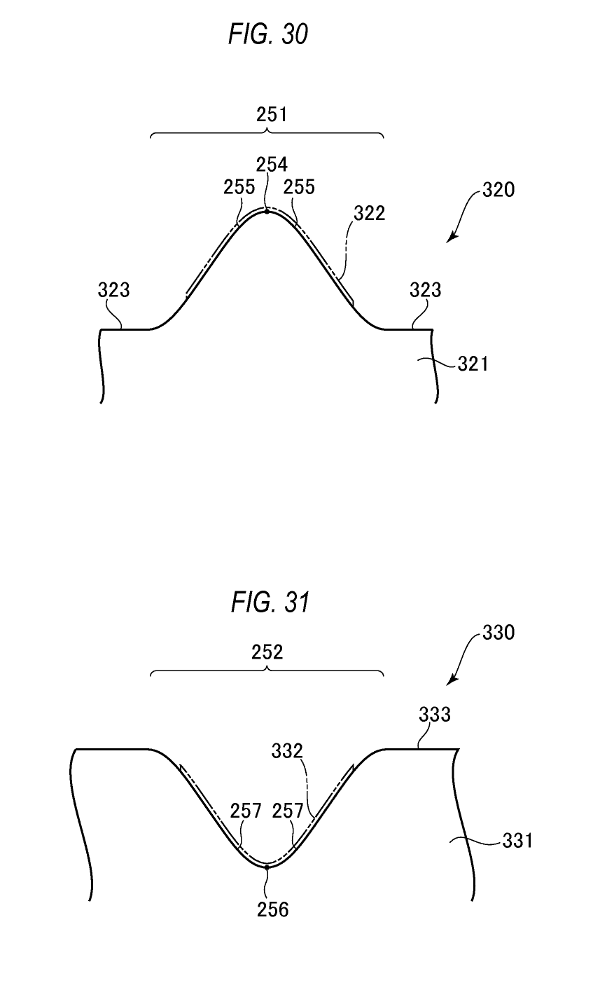

FIG. 30 is a sectional view of an antenna unit 320 according to a twenty-second embodiment.

A case in which only the projection 251 is formed on a resin substrate 321 will be described in the present embodiment. As illustrated in FIG. 30, the top portion of the projection 251 is curved, and the inclined surfaces 255 inclined from the uppermost portion 254 are formed. Only one cycle of the projection 251 is wound and formed in plan view.

As illustrated in FIG. 30, an antenna conductor 322 is formed from the top portion of the projection 251, that is, the uppermost portion 254 of the projection 251, throughout the inclined surfaces 255 on both sides. The antenna conductor 322 may be further formed throughout the flat surfaces 323 of the resin substrate 321 from the inclined surfaces 255 on both sides. Only one circle of the antenna conductor 322 is formed along the top portion of the projection 251.

In this way, the antenna conductor 322 can be formed on the top portion of the projection 251 to form the antenna conductor 322 in the thickness direction of the resin substrate 321 because the top portion of the projection 251 is inclined. Therefore, the line width of the antenna conductor 322 can be substantially increased, and the resistance of the antenna conductor 322 can be reduced. This increases the induction voltage, and the antenna unit 320 can be downsized.

### Twenty-Third Embodiment

FIG. 31 is a sectional view of an antenna unit 330 according to a twenty-third embodiment.

A case in which only the recess 252 is formed on a resin substrate 331 will be described in the present embodiment. As illustrated in FIG. 31, the bottom portion of the recess 252 is curved, and the inclined surfaces 257 inclined from the lowermost portion 256 are formed. Only one cycle of the recess 252 is wound and formed in plan view.

As illustrated in FIG. 31, an antenna conductor 332 is formed from the bottom portion of the recess 252, that is, the lowermost portion 256 of the recess 252, throughout the inclined surfaces 257 on both sides. The antenna conductor 332 may be further formed throughout flat surfaces 333 of the resin substrate 331 from the inclined surfaces 257 on both sides. Only one circle of the antenna conductor 332 is formed along the bottom portion of the recess 252.

In this way, the antenna conductor 332 can be formed on the bottom portion of the recess 252 to form the antenna conductor 332 in the thickness direction of the resin substrate 331 because the bottom portion of the recess 252 is inclined. Therefore, the line width of the antenna conductor 332 can be substantially increased, and the resistance of the antenna conductor 332 can be reduced. This increases the induction voltage, and the antenna unit 330 can be downsized.

### Twenty-Fourth Embodiment

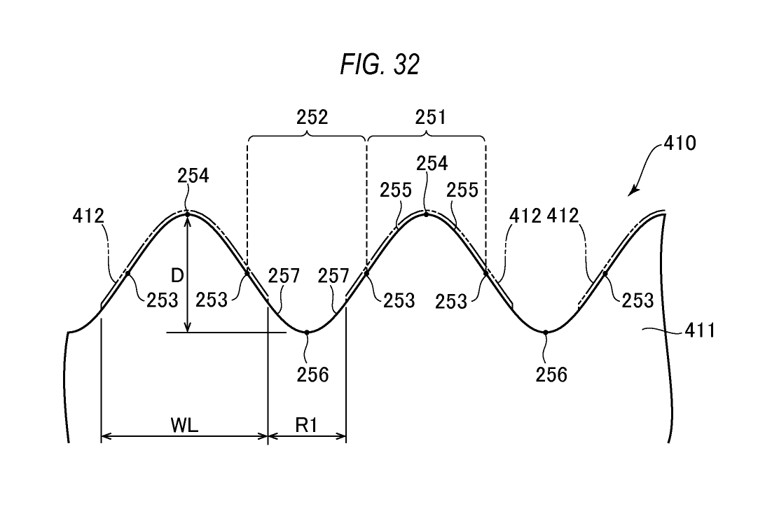

FIG. 32 is a sectional view of an antenna unit 410 according to a twenty-fourth embodiment.

In the case described in the present embodiment, the projection 251 and the recess 252 are formed on a resin substrate 411, and an antenna conductor 412 is formed on the top portion of the projection 251 and is not formed on the lowermost portion 256 of the recess 252. The shapes of the projection 251 and the recess 252 are the same as in the eleventh embodiment.

As illustrated in FIG. 32, the antenna conductor 412 is formed from the uppermost portion 254 of the projection 251 throughout the inclined surfaces 255 on both sides, the boundary portions 253, and the inclined surfaces 257 of the recess 252. Therefore, the antenna conductor 412 is formed only around the projection 251 in the present embodiment.

In this way, the antenna conductor 412 can be formed only around the projection 251 to form the projection 251 in the same spiral shape as the path of the antenna conductor 412 in plan view.

Therefore, the antenna conductor 412 can be simply formed in the direction of the continuous projection 251. Therefore, the antenna conductor 412 does not have to be alternately formed on the top portions of the projections 251 and the bottom portions of the recesses 252, and the transition portion 258 does not have to be formed. As a result, the antenna unit 410 can be easily manufactured.

The antenna conductor 412 may not be formed up to the boundary portion 253. If the antenna conductor 412 has only one circle, the mode is the same as the twenty-second embodiment. Therefore, it is preferable to form the antenna conductor 412 in a spiral shape of two or more circles.

The impedance of the antenna unit 410 of an example in which the antenna conductor 412 is formed only around the projection 251 and the impedance of an antenna unit of a comparative example are analyzed by an electromagnetic field simulator.

In the example, the projections and recesses of the resin substrate 411 are formed in a sine wave shape. A polyimide resin is used for the resin substrate 411, and the depth D from the projection 251 to the recess 252 is 0.2 mm as illustrated in FIG. 32. As for the dimension in plan view, the line width WL of the antenna conductor 412 is 0.2 mm, and the interval R1 between the antenna conductors 412 is 0.05 mm. The antenna conductor 412 is a copper foil with a thickness of 25 μm. The number of circles of the antenna conductor 412, the length L3 of the innermost circle of the antenna conductor 412 in the longitudinal direction, the length L4 in the short direction, and the like are the same as in FIG. 20A.

The comparative example is also the same as in FIGS. 21A and 21B.

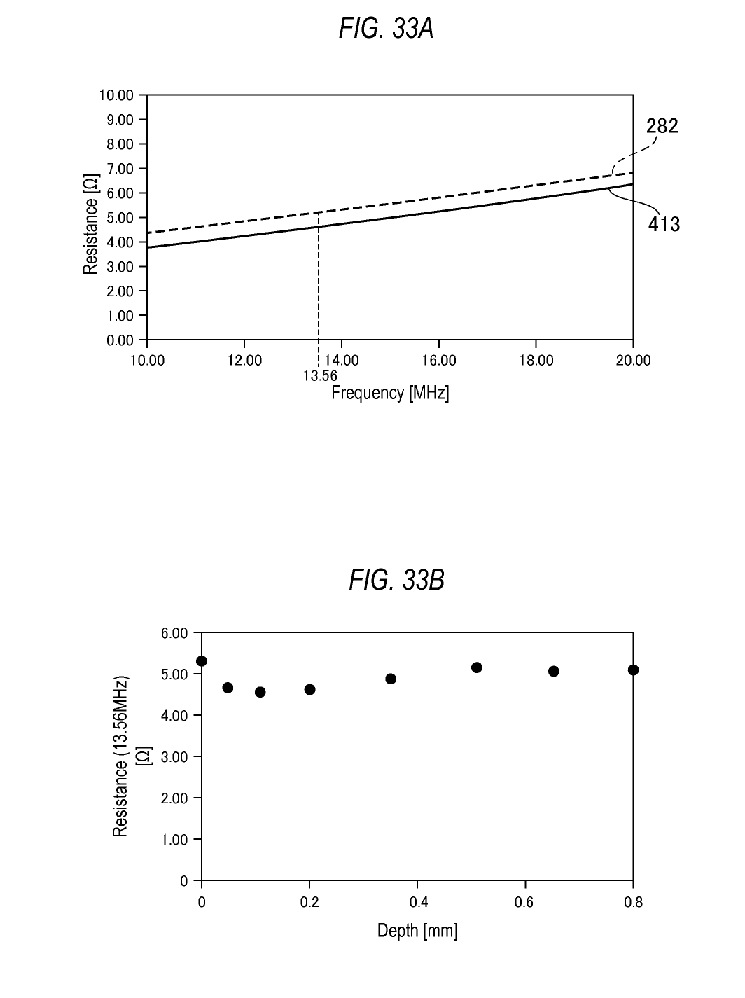

FIG. 33A is a diagram comparing the resistance (real part of impedance) of the antenna unit 410 of the example and the resistance of the antenna unit of the comparative example. In FIG. 33A, the vertical axis indicates the resistance [Ω], and the horizontal axis indicates the frequency [MHz]. A solid line 413 indicates a characteristic line of the resistance of the antenna unit 410 in the example, and a dashed line 282 indicates a characteristic line of the resistance of the antenna unit in the comparative example.

As illustrated in FIG. 33A, the resistance of the antenna unit of the comparative example is 5.3 [Ω] at frequency 13.56 [MHz] for example, while the resistance of the antenna unit 410 of the example is 4.6 [Ω]. Therefore, it can be confirmed that the antenna unit 410 of the example can reduce the resistance by about 13% compared to the antenna unit of the comparative example. This increases the induction voltage obtained by the antenna unit 410, and the antenna unit 410 can be downsized.

FIG. 33B is a view illustrating a relationship between the depth D and the resistance reduction effect of the antenna unit 410 of the example. In FIG. 33B, the vertical axis indicates the resistance [Ω], and the horizontal axis indicates the depth D [mm]. The frequency is 13.56 [MHz].

As illustrated in FIG. 33B, the resistance reduction effect is the greatest from depth 0 [mm], in which the resistance in the comparative example is 5.3Ω, to depth D=0.11 [mm]. There is a resistance reduction effect at depth D=0.05 [mm] or more, preferably, 0.05 [mm] or more and 0.25 [mm] or less. Therefore, there is a downsizing effect of antenna in this range.

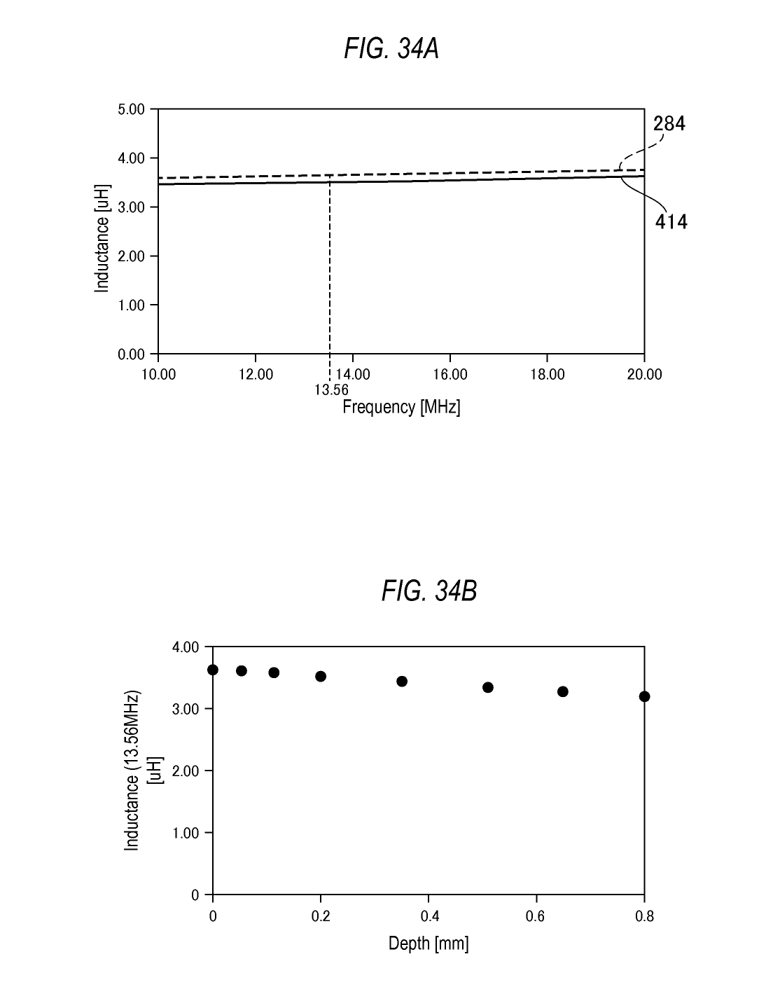

Meanwhile, FIG. 34A is a diagram comparing the inductance of the antenna unit 410 of the example and the inductance of the antenna unit of the comparative example. In FIG. 34A, the vertical axis indicates the inductance [μH], and the horizontal axis indicates the frequency [MHz]. A solid line 414 indicates a characteristic line of the inductance of the antenna unit 410 in the example, the dashed line 284 indicates a characteristic line of the inductance of the antenna unit in the comparative example.

As illustrated in FIG. 34A, the inductance of the antenna of the comparative example is 3.6 [μH] at frequency 13.56 [MHz] for example, and the inductance of the antenna unit 410 of the example is 3.5 [μH]. Therefore, the antenna unit 410 of the example and the antenna unit of the comparative example have substantially the same inductance.

FIG. 34B is a view illustrating a relationship between the depth D and change in the inductance of the antenna unit 410 of the example. In FIG. 34B, the vertical axis indicates the inductance [μH], and the horizontal axis indicates the depth D [mm]. The frequency is 13.56 [MHz].

As illustrated in FIG. 34B, it can be recognized that the inductance hardly changes even if the depth D is deep. As described, while the inductance is 3.6 [μH] when the depth D is 0 [mm] which corresponds to the comparative example, the inductance is 3.5 [μH] when the depth D is 0.25 [mm].

### Twenty-Fifth Embodiment

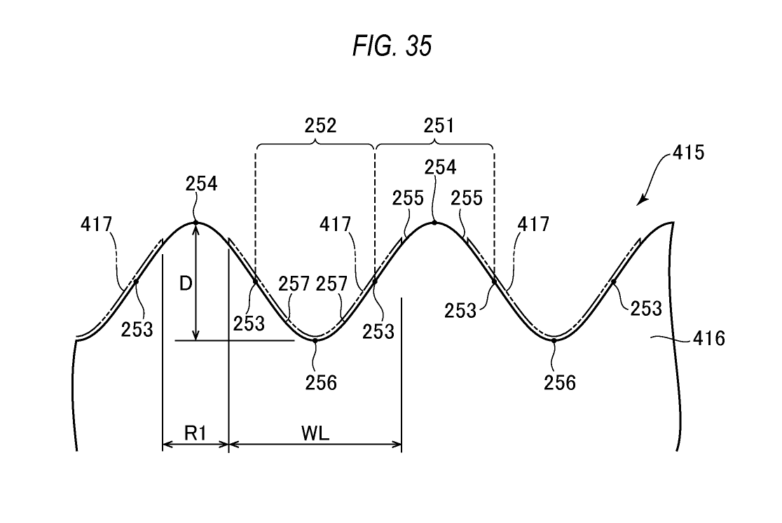

FIG. 35 is a sectional view of an antenna unit 415 according to a twenty-fifth embodiment.

In the case described in the present embodiment, the projection 251 and the recess 252 are formed on a resin substrate 416, and an antenna conductor 417 is formed on the bottom portion of the recess 252 and is not formed on the uppermost portion 254 of the projection 251. The shapes of the projection 251 and the recess 252 are the same as in the eleventh embodiment.

As illustrated in FIG. 35, the antenna conductor 417 is formed from the lowermost portion 256 of the recess 252 throughout the inclined surfaces 257 on both sides, the boundary portions 253, and the inclined surfaces 255 of the projection 251. Therefore, the antenna conductor 417 is formed only around the recess 252 in the present embodiment.

In this way, the antenna conductor 417 can be formed only around the recess 252 to form the recess 252 in the same spiral shape as the path of the antenna conductor 417 in plan view.

Therefore, the antenna conductor 417 can be simply formed in the direction of the continuous recess 252. Therefore, the antenna conductor 417 does not have to be alternately formed on the top portions of the projections 251 and the bottom portions of the recesses 252, and the transition portion 258 does not have to be formed. As a result, the antenna unit 415 can be easily manufactured.

The antenna conductor 417 may not be formed up to the boundary portion 253. If the antenna conductor 417 has only one circle, the mode is the same as the twenty-third embodiment. Therefore, it is preferable to form the antenna conductor 417 in a spiral shape of two or more circles.

The impedance of the antenna unit 415 of the example provided with the antenna conductor 417 only around the recess 252 and the impedance of the antenna unit of the comparative example are analyzed by an electromagnetic field simulator.

In the example, the projections and recesses of the resin substrate 416 are formed in a sine wave shape. A polyimide resin is used for the resin substrate 416, and the depth D from the projection 251 to the recess 252 is 0.2 mm as illustrated in FIG. 35. As for the dimension in plan view, the line width WL of the antenna conductor 417 is 0.2 mm, and the interval R1 between the antenna conductors 417 is 0.05 mm. The antenna conductor 417 is a copper foil with a thickness of 25 μm. The number of circles of the antenna conductor 417, the length L3 of the innermost circle of the antenna conductor 417 in the longitudinal direction, the length L4 in the short direction, and the like are the same as in FIG. 20A.

The comparative example is the same as in FIGS. 21A and 21B.

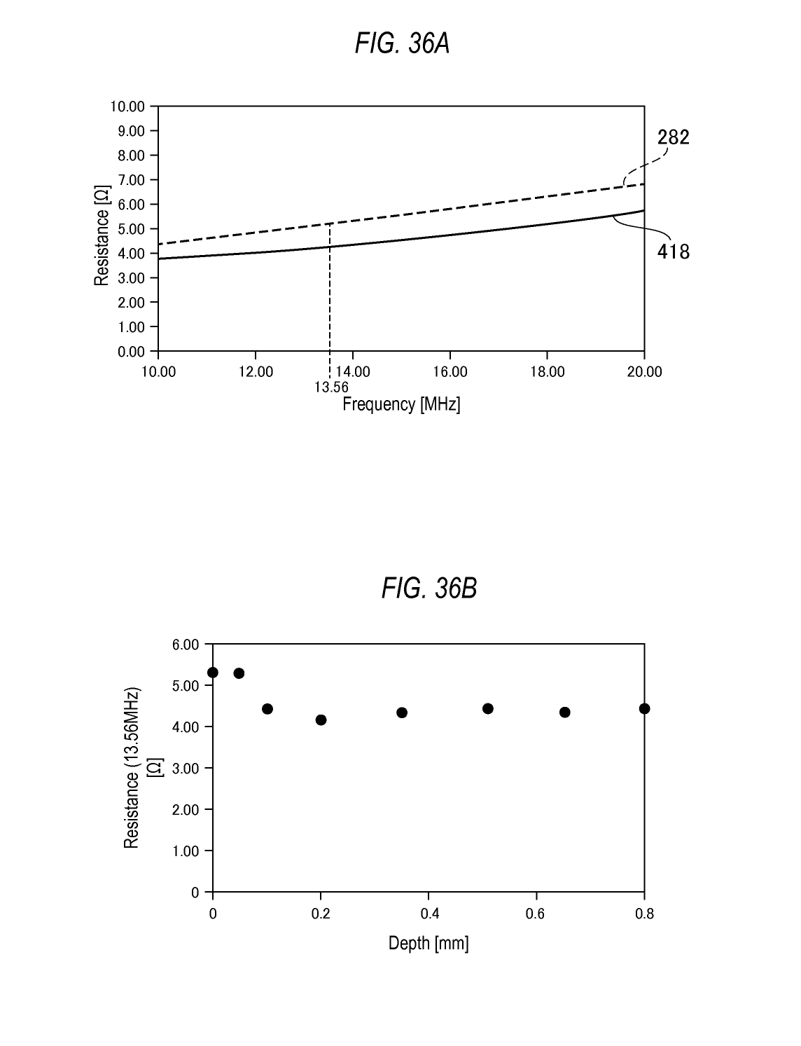

FIG. 36A is a diagram comparing the resistance (real part of impedance) of the antenna unit 415 of the example and the resistance of the antenna unit of the comparative example. In FIG. 36A, the vertical axis indicates the resistance [Ω], and the horizontal axis indicates the frequency [MHz]. A solid line 418 indicates a characteristic line of the resistance of the antenna unit 415 in the example, and the dashed line 282 indicates a characteristic line of the resistance of the antenna unit in the comparative example.

As illustrated in FIG. 36A, the resistance of the antenna unit of the comparative example is 5.3 [≠] at frequency 13.56 [MHz] for example, while the resistance is 4.2 [Ω] in the antenna unit 415 of the example. Therefore, it can be confirmed that the antenna unit 415 of the example can reduce the resistance by about 21% compared to the antenna unit of the comparative example. This increases the induction voltage obtained by the antenna unit 415, and the antenna unit 415 can be downsized.

FIG. 36B is a view illustrating a relationship between the depth D and the resistance reduction effect of the antenna unit 415 of the example. In FIG. 36B, the vertical axis indicates the resistance [Ω], and the horizontal axis indicates the depth D [mm]. The frequency is 13.56 [MHz].

As illustrated in FIG. 36B, the resistance reduction effect is the greatest from depth 0 [mm], in which the resistance in the comparative example is 5.2Ω, to depth D=0.2 [mm]. There is a resistance reduction effect at depth D=0.1 [mm] or more. The induction voltage obtained by the antenna unit 415 increases under the condition of this depth D, and the antenna unit 415 can be downsized.

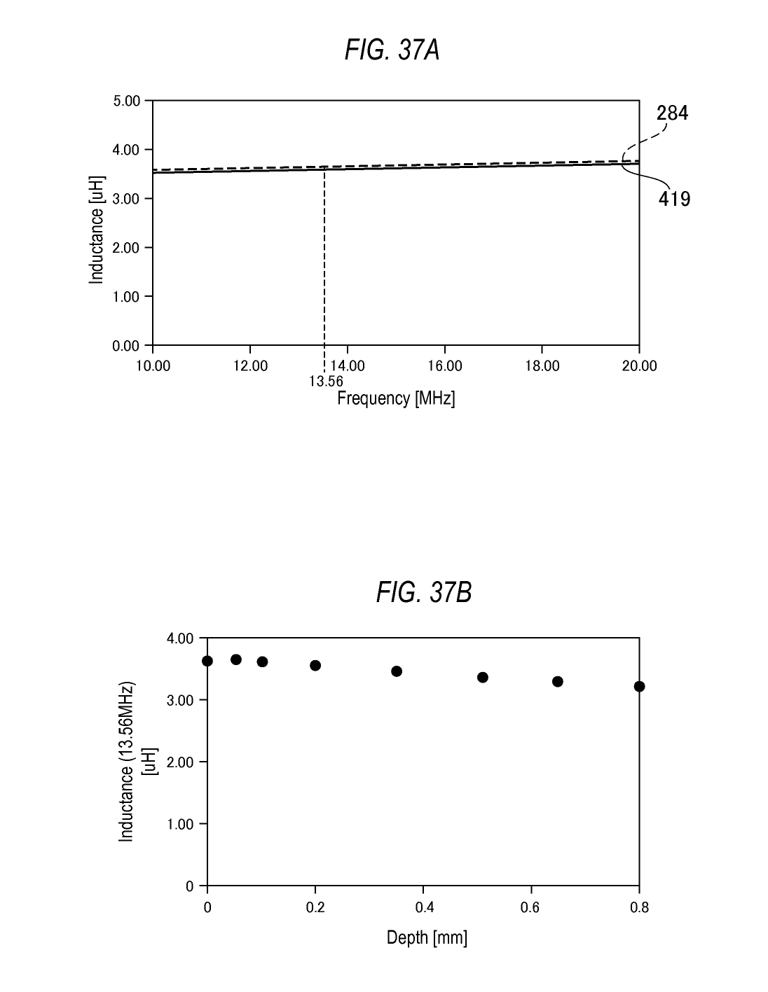

Meanwhile, FIG. 37A is a diagram comparing the inductance of the antenna unit 415 of the example and the inductance of the antenna unit of the comparative example. In FIG. 37A, the vertical axis indicates the inductance [μH], and the horizontal axis indicates the frequency [MHz]. A solid line 419 indicates a characteristic line of the inductance of the antenna unit 415 in the example, and the dashed line 284 indicates a characteristic line of the inductance of the antenna unit in the comparative example.

As illustrated in FIG. 37A, the inductance of the antenna of the comparative example is 3.6 [μH] at frequency 13.56 [MHz] for example, and the inductance of the antenna unit 415 of the example is 3.6 [μH]. Therefore, the antenna unit 415 of the example and the antenna unit of the comparative example have substantially the same inductance.

FIG. 37B is a view illustrating a relationship between the depth D and change in the inductance of the antenna unit 415 of the example. In FIG. 37B, the vertical axis indicates the inductance [μH], and the horizontal axis indicates the depth D [mm]. The frequency is 13.56 [MHz].

As illustrated in FIG. 37B, it can be recognized that the inductance hardly changes even if the depth D is deep. As described, while the inductance is 3.6 [μH] when the depth D is 0 [mm] which corresponds to the comparative example, the inductance is 3.6 [μH] when the depth D is 0.2 [mm]

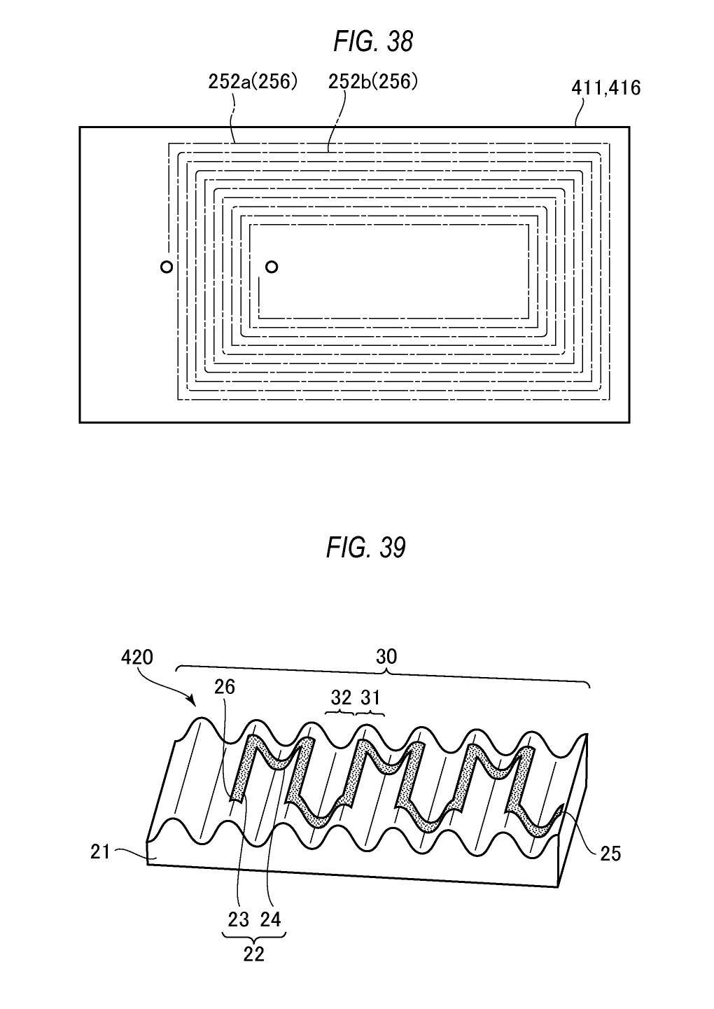

FIG. 38 is a plan view illustrating the resin substrate 411 of the twenty-fourth embodiment and the resin substrate 416 of the twenty-fifth embodiment. An alternate short and long dash line indicates the lowermost portion 256 of the recess 252, and the uppermost portion 254 of the projection 251 is not illustrated.

As illustrated in FIG. 38, although the recesses 252 (and the projections 251) are wound and formed in a spiral shape, the transition portion is not formed, and there is no transition between the projections 251 and the recesses 252.

Although the present invention has been described along with various embodiments, the present invention is not limited to the embodiments. Changes and the like can be made within the scope of the present invention, and the embodiments may be appropriately combined.

Although the positional relationship between the antenna unit 20 and the mounting section 11 is as illustrated in FIG. 3 in the description of the first to tenth embodiments, the positional relationship is not limited to this mode.

Although the meandering width portion is alternately formed on the top portions of the projections 31 and the bottom portions of the recesses 32 in the description of the first to seventh embodiments, the arrangement is not limited to this. For example, one meandering width portion 23 may be formed on the top portion of the projection 31, and one of the adjacent meandering width portions 23 may also be formed on the top portion of the projection 31. FIG. 39 is a perspective view illustrating an antenna unit 420 according to a twenty-sixth embodiment. In the antenna unit 420 of the present embodiment, the meandering width portions 23 are formed only on the top portions of the projection 31.

Similarly, one meandering width portion 23 may be formed on the bottom portion of the recess 32, and one of the adjacent meandering width portions 23 may also be formed on the bottom portion of the recess 32. Therefore, the meandering width portion 23 may not be alternately formed on the top portion of the projection 31 and the bottom portion of the recess 32.

An IC card is used as a wireless communication medium, and a reader/writer apparatus is used as a wireless communication apparatus in the description of the eleventh to twenty-fifth embodiments. However, the arrangement is not limited to this, and the present invention can be applied to an apparatus including an antenna conductor formed in a coil shape.

Although the electromagnetic-induction RFID system has been described in the eleventh to twenty-fifth embodiments, the arrangement is not limited to this. The present invention can also be used in and RFID system of an electric wave type, an electromagnetic field resonance coupling type (electromagnetic resonance type), or the like.

The projections and the recesses are alternately wound and formed on the upper surface of the substrate, and the antenna conductor is alternately formed, circle-by-circle, on the top portions of the projections and the bottom portions of the recesses in the description of the eleventh to twenty-second embodiments. However, the arrangement is not limited to this. For example, the projections and the recesses may be alternately wound and formed on the upper surface of the substrate. One circle of the antenna conductor may be formed on the top portion of the projection, and one of the previous circle and the next circle may also be formed on the top portion of the projection.

Similarly, one circle of the antenna conductor may be formed on the bottom portion of the recess, and one of the previous circle and the next circle may be formed on the bottom portion of the recess. Therefore, the antenna conductor may not be alternately formed on the top portion of the projection and the bottom portion of the recess.

According to the present invention, the antenna apparatus can be downsized while keeping necessary characteristics.

It should be noted that the above embodiments merely illustrate concrete examples of implementing the present invention, and the technical scope of the present invention is not to be construed in a restrictive manner by these embodiments. That is, the present invention may be implemented in various forms without departing from the technical spirit or main features thereof.

What is claimed is:

1. An antenna apparatus performing at least one of transmission and reception of data, the antenna apparatus comprising:
a substrate including projections and recesses formed parallel to and adjacent to each other on an upper surface; and
an antenna conductor continuously formed to meander in one direction along top portions of the projections or bottom portions of the recesses.

2. An antenna apparatus performing at least one of transmission and reception of data, the antenna apparatus comprising:
a substrate including projections and recesses formed parallel to and adjacent to each other on an upper surface; and
an antenna conductor continuously formed to meander in one direction along top portions of the projections and bottom portions of the recesses.

3. The antenna apparatus according to claim 1, wherein
the antenna conductor comprises meandering width portions formed parallel to each other on the substrate and meandering extension portions formed by connecting the meandering width portions, and
the meandering width portions are formed along the top portions of the projections and the bottom portions of the recesses.

4. The antenna apparatus according to claim 3, wherein
the meandering width portions are alternately formed along the top portions of the projections and the bottom portions of the recesses.

5. The antenna apparatus according to claim 3, wherein
the meandering extension portions are formed by connecting the meandering width portions through boundary portions between the projections and the recesses,
the boundary portions are inclined in a thickness direction with respect to a mounting surface of the substrate, and surfaces of the boundary portions are exposed in plan view.

6. An antenna apparatus performing at least one of transmission and reception of data, the antenna apparatus comprising:
a substrate including projections or recesses wound and formed on an upper surface; and
an antenna conductor formed along top portions of the projections or bottom portions of the recesses.

7. An antenna apparatus performing at least one of transmission and reception of data, the antenna apparatus comprising:
a substrate including projections and recesses alternately wound and formed on an upper surface; and
an antenna conductor formed in a spiral shape along top portions of the projections or bottom portions of the recesses.

8. The antenna apparatus according to claim 7, wherein
the antenna conductor is formed by two or more circles in a spiral shape along the top portions of the projections or the bottom portions of the recesses, around the top portions of the projections or the bottom portions of the recesses.

9. An antenna apparatus performing at least one of transmission and reception of data, the antenna apparatus comprising:
a substrate including projections and recesses alternately wound and formed on an upper surface; and
an antenna conductor formed in a spiral shape along top portions of the projections and bottom portions of the recesses.

10. The antenna apparatus according to claim 9, wherein
the antenna conductor is alternately formed, circle-by-circle, on the top portions of the projections and the bottom portions of the recesses.

11. The antenna apparatus according to claim 10, wherein
the projections and the recesses are alternately wound and formed in independent annular shapes in different sizes, and a transition portion inclined toward a position of start of each circle of the antenna conductor is formed cycle-by-cycle.

12. The antenna apparatus according to claim 10, wherein
the antenna conductor is alternately formed, circle-by-circle, on the top portions of the projections and the bottom portions of the recesses through boundary portions between the projections and the recesses.

13. The antenna apparatus according to claim 12, wherein
the boundary portions are inclined in a thickness direction with respect to a mounting surface of the substrate, and surfaces of the boundary portions are exposed in plan view.

14. The antenna apparatus according to claim 10, wherein
the projections and recesses are alternately wound and formed, cycle-by-cycle, in a spiral shape, and a transition portion that inclines in a thickness direction of the substrate to make a transition from the projection to the recess or from the recess to the projection at each cycle is formed.

15. The antenna apparatus according to claim 1, wherein
at least one of the top portions of the projections and the bottom portions of the recesses is curved, and
the antenna conductor is formed throughout curved inclined surfaces of the at least one of the top portions of the projections and the bottom portions of the recesses.

16. The antenna apparatus according to claim 2, wherein
at least one of the top portions of the projections and the bottom portions of the recesses is curved, and
the antenna conductor is formed throughout curved inclined surfaces of the at least one of the top portions of the projections and the bottom portions of the recesses.

17. The antenna apparatus according to claim 6, wherein
at least one of the top portions of the projections and the bottom portions of the recesses is curved, and
the antenna conductor is formed throughout curved inclined surfaces of the at least one of the top portions of the projections and the bottom portions of the recesses.

18. The antenna apparatus according to claim 7, wherein
at least one of the top portions of the projections and the bottom portions of the recesses is curved, and
the antenna conductor is formed throughout curved inclined surfaces of the at least one of the top portions of the projections and the bottom portions of the recesses.

19. The antenna apparatus according to claim 9, wherein
at least one of the top portions of the projections and the bottom portions of the recesses is curved, and
the antenna conductor is formed throughout curved inclined surfaces of the at least one of the top portions of the projections and the bottom portions of the recesses.

20. The antenna apparatus according to claim 2, wherein
the antenna conductor comprises meandering width portions formed parallel to each other on the substrate and meandering extension portions formed by connecting the meandering width portions, and
the meandering width portions are formed along the top portions of the projections and the bottom portions of the recesses.

21. An electronic device comprising:
an antenna unit performing at least one of transmission and reception of data; and
a communication circuit performing at least one of conversion of data received at the antenna unit and conversion to data to be transmitted from the antenna unit,
the antenna unit comprising:
a substrate including projections and recesses formed parallel to and adjacent to each other on an upper surface; and
an antenna conductor continuously formed to meander in one direction along top portions of the projections or bottom portions of the recesses.

22. An electronic device comprising:
an antenna unit performing at least one of transmission and reception of data; and
a communication circuit performing at least one of conversion of data received at the antenna unit and conversion to data to be transmitted from the antenna unit,
the antenna unit comprising:
a substrate including projections and recesses formed parallel to and adjacent to each other on an upper surface; and
an antenna conductor continuously formed to meander in one direction along top portions of the projections and bottom portions of the recesses.

23. An electronic device comprising:
an antenna unit performing at least one of transmission and reception of data; and
a communication circuit performing at least one of conversion of data received at the antenna unit and conversion to data to be transmitted from the antenna unit,
the antenna unit comprising:
a substrate including projections or recesses wound and formed on an upper surface; and
an antenna conductor formed along top portions of the projections or bottom portions of the recesses.

24. An electronic device comprising:
an antenna unit performing at least one of transmission and reception of data; and
a communication circuit performing at least one of conversion of data received at the antenna unit and conversion to data to be transmitted from the antenna unit,
the antenna unit comprising:
a substrate including projections and recesses alternately wound and formed on an upper surface; and
an antenna conductor formed in a spiral shape along top portions of the projections or bottom portions of the recesses.

25. An electronic device comprising:
an antenna unit performing at least one of transmission and reception of data; and
a communication circuit performing at least one of conversion of data received at the antenna unit and conversion to data to be transmitted from the antenna unit,
the antenna unit comprising:
a substrate including projections and recesses alternately wound and formed on an upper surface; and
an antenna conductor formed in a spiral shape along top portions of the projections and bottom portions of the recesses.
